(19) United States
(12) Patent Application Publication
(10) Pub. No.: US 2023/0194286 A1
(43) Pub. Date: Jun. 22, 2023

(54) Systems, Methods, and Apparatus for using Remote Assistance to Navigate in an Environment

(71) Applicant: Waymo LLC, Mountain Vew, CA (US)

(72) Inventors: Collin Winter, San Francisco, CA (US); Vishay Nihalani, San Francisco, CA (US)

(21) Appl. No.: 17/558,018

(22) Filed: Dec. 21, 2021

(51) Int. Cl. G01C 21/34; G01C 21/36; H04W 4/40

(52) U.S. Cl. CPC G01C 21/3492; G01C 21/3664; G01C 21/3691; H04W 4/40

(57) ABSTRACT

Example embodiments relate to using remote assistance for vehicle navigation. An example apparatus may comprise a memory configured to store navigation options and a computing device. The computing device may be configured to receive a request for assistance comprising a situation to be encountered by a vehicle along a planned travel route and to determine one or more navigation options for enabling the vehicle to navigate the situation. The computing device may also be configured to select at least one navigation option of the one or more navigation options. Further, the computing device may be configured to generate a response to the request for assistance that includes instructions for performing the at least one navigation option to navigate the situation and to send the response to the vehicle for execution of the instructions.

### BACKGROUND

This background description is provided for the purpose of generally presenting the context of the disclosure. Unless otherwise indicated herein, material described in this section is neither expressly nor impliedly admitted to be prior art to the present disclosure or the appended claims.

Vehicles may be used to complete various types of tasks, including transportation of objects and people. With advances in technology, some vehicles may be configured with computing systems that enable the vehicles to operate in a partial or fully autonomous mode. When operating in a partial or fully autonomous mode, some or all of the navigation aspects of vehicle operation may be controlled by a vehicle control system rather than by a human driver. Autonomous operation of a vehicle may involve systems sensing the vehicle's surrounding environment to enable a computing system to plan and safely navigate.

### SUMMARY

Example embodiments described herein relate to techniques for providing remote assistance to help a vehicle (e.g., an autonomous vehicle) navigate along a travel route in an environment. The techniques may enable a remote assistant (e.g., a human assistant or a computing assistant) to assist one or more systems of a vehicle to safely navigate situations (e.g., road conditions, traffic conditions, obstacles, etc.) that may be encountered along the travel route. During the operation of the vehicle, a vehicle system may identify situations along or near the travel route of the vehicle and may send a request to a remote assistant to obtain help for navigating the identified situations. The remote assistant may determine navigation options for the identified situations and may send the navigation options to the vehicle system to assist the vehicle in navigating the situations.

In one aspect, an example apparatus is provided. The apparatus may comprise a memory configured to store navigation options and a computing device. The computing device may be configured to receive a request for assistance comprising a situation to be encountered by a vehicle along a planned travel route and to determine one or more navigation options for enabling the vehicle to navigate the situation. The computing device may also be configured to select at least one navigation option of the one or more navigation options. Further, the computing device may be configured to generate a response to the request for assistant that includes instructions for performing the at least one navigation option to navigate the situation and to send the response to the vehicle for execution of the instructions.

In another aspect, an example method is provided. The method may comprise receiving a request for assistance comprising a situation to be encountered by a vehicle along a planned travel route and determining one or more navigation options for enabling the vehicle to navigate the situation. The method may also comprise selecting at least one navigation option of the one or more navigation options. Further, the method may comprise generating a response to the request for assistance that includes instructions for performing at least one navigation option to navigate the situation and sending the response to the vehicle.

In another aspect, an example method is provided. The method may comprise determining a travel route for a vehicle and receiving information about one or more situations in an environment from a remote source. The method may also comprise identifying a situation of the one or more situations along the travel route for requesting navigation assistance and in response to an occurrence of a triggering event, causing a request for assistance to be sent to obtain options for navigating the situation. The request for assistance may be sent before the vehicle encounters the situation. Further, the method may comprise receiving at least one instruction to perform one or more navigation options for navigating the situation and executing the at least one instruction to cause the vehicle to perform the one or more navigation options when the identified situation is encountered.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 is a functional block diagram illustrating a vehicle, according to example implementations;

FIG. 2A illustrates a side view of a vehicle, according to one or more example embodiments;

FIG. 2B illustrates a top view of a vehicle, according to one or more example embodiments;

FIG. 2C illustrates a front view of a vehicle, according to one or more example embodiments;

FIG. 2D illustrates a back view of a vehicle, according to one or more example embodiments;

FIG. 2E illustrates an additional view of a vehicle, according to one or more example embodiments:

FIG. 3 is a simplified block diagram for a computing system, according to one or more example embodiments;

FIG. 4 is a system for wireless communication between computing devices and a vehicle, according to one or more example embodiments;

FIG. 5 illustrates a computing device displaying a graphical user interface for enabling remote assistance, according to one or more example embodiments;

FIG. 6A illustrates a scenario involving a vehicle encountering an obstacle during navigation, according to one or more example embodiments:

FIG. 6B further illustrates the vehicle determining navigation options in response to encountering the obstacle in the scenario shown in FIG. 6A, according to one or more example embodiments;

FIG. 6C illustrates a graphical user interface for enabling remote assistance to be provided to the vehicle shown in FIGS. 6A and 6B, according to one or more example embodiments;

FIG. 7 is a flow chart of a method for providing remote assistance to a vehicle, according to one or more example embodiments;

FIG. 8 is a flow chart of a method for enabling a vehicle to request remote assistance, according to one or more example embodiments; and

FIG. 9 is a schematic diagram of a computer program, according to one or more example embodiments.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Advancements in computing, sensors, and other technologies have enabled vehicles to safely navigate autonomously along a travel route without requiring input from a human driver. By processing measurements of the surrounding environment from vehicle sensors in near real-time, a vehicle can transport passengers or objects between locations while avoiding obstacles, obeying traffic requirements, and performing other operations that are typically performed by a human driver. The shift of the control of the vehicle over to a vehicle system (e.g., a vehicle control or navigation system) may permit passengers to devote their attention to tasks other than driving.

During operation, a vehicle capable of autonomous or semi-autonomous operation may encounter complex or unexpected situations that can interfere with the vehicle's planned navigation strategy. In some cases, a vehicle's sensor system may detect the presence of an unexpected obstacle or multiple obstacles that may limit the current navigation plan and/or the travel route of the vehicle. Without a human driver to interpret the situation, the vehicle may remain stopped as a default until obtaining sufficient measurements of environment changes that enable safely proceeding. In some instances, however, the vehicle may remain stopped for a substantial amount of time if the environment remains static and the vehicle systems are not able to identify a safe strategy for further navigation.

Because autonomous vehicles (e.g., autonomously driven vehicles) may navigate in various locations, there are numerous situations that may cause issues for the vehicle navigation system and/or other vehicle systems. For example, a parking lot may include parked vehicles, pedestrians, shopping carts, and other potential obstacles that may interfere with an autonomous vehicle's ability to navigate per the lines and rules of the parking lot. In some cases, the navigation system of an autonomous vehicle may become temporarily stranded if too many obstacles interfere with potential travel routes. Similarly, encountering an accident between other vehicles, road construction, traffic conditions, and other driving conditions are other example scenarios that may unexpectedly disrupt an autonomous vehicle's path of navigation or travel. These are just a few examples where the current navigation strategy for an autonomous vehicle may be impacted and potentially limited in some way.

Example embodiments described herein relate to techniques that enable one or more systems of a vehicle (e.g., an autonomous or autonomously driven vehicle) to obtain remote assistance (e.g., a computing assistant or human operator) to help navigate and/or maneuver the vehicle in an environment. When a vehicle system determines that the vehicle may encounter a situation along a travel route where navigation progress may be impeded in some way (e.g., by an obstacle in a current or planned driving route, a narrow passageway, an accident, road construction, a road condition, a traffic condition, or other conditions or situations in the environment that may impact the navigation of the vehicle), the vehicle system may request and obtain remote assistance (e.g., human input) that may help the vehicle effectively overcome the situation.

The vehicle system may submit a request to obtain remote assistance that may help resolve situations that a human driver would typically be able to overcome. For example, remote assistance may be used to help the vehicle system in various ways, such as determining travel routes, avoiding obstacles, monitoring performance of routes, adjusting or modifying navigation paths, confirming or denying navigation options or maneuvers proposed by a vehicle navigation system, checking on passengers, and/or performing other forms of remote assistance. In some embodiments, the assistance may involve a remote assistant (e.g., a human guide or computing assistant) that may review a vehicle's navigation path and provide assistance to help the vehicle system overcome navigation situations (e.g., road or traffic conditions) encountered along the travel route of the vehicle. For example, the remote assistant may identify a navigation strategy for the vehicle to execute and may subsequently monitor the progress of the vehicle according to the travel route selected by the remote assistant and/or the vehicle system. While monitoring the vehicle navigating along the travel route, the remote assistant may provide further assistance to a vehicle system if necessary. In some instances, the remote assistant may provide instructions to cause the vehicle to temporarily stop, change route, and/or perform other maneuvers.

In some implementations, a system of a vehicle may determine or identify potential or predetermined conditions or situations (e.g., obstacles, road conditions, traffic conditions, etc.) near or along a travel route that may require remote assistance. The vehicle system may request remote assistance to help the vehicle system (e.g., a vehicle control or navigation system) navigate the situations. The vehicle system may obtain information about the situations from a remote source (e.g., a map system, a GPS system, an assistance center, a fleet management system, etc.). The situation may be determined based on historical or previous data that occurred along the travel route. In some examples, the remote source and/or the vehicle system may obtain information about the situations from other vehicles and/or remote assistants.

After receiving a report or notification about a situation in the environment, a remote source may be configured to notify vehicles in the environment about the situation. For instance, when one or more vehicles experience a situation at a particular route location due to a road or traffic condition, a system of the vehicles may notify the remote source about the situation. In some examples, the remote source may identify a situation after receiving a particular number of reports or notifications. Once the remote source identifies the situation in an environment, the remote source may notify or inform a system of each vehicle in a geographic area around the situation and/or a fleet management system. For example, the remote source may notify a vehicle about the situation that is within a particular distance of the location of the situation. However, once a particular number of vehicles successfully navigate along a travel route without encountering the situation, the remote source may no longer inform vehicles about the situation. Further, the remote source may notify vehicles in the environment that the situation may no longer exist or impede the travel of a vehicle.

After a system of a vehicle determines or receives information about a predetermined or known situation along a travel route, the vehicle system may request remote assistance before the vehicle reaches or encounters the situation. The vehicle system may use the information about the situation to develop a trigger for requesting remote assistance before the vehicle encounters the situation. In some examples, a remote assistance process may be triggered in response to the vehicle system identifying the situation along the travel route of a vehicle. In other examples, when a vehicle is within a threshold distance from the situation on the travel route, a vehicle system may be triggered to request remote assistance. Further, a vehicle system may be triggered to request remote assistance when the vehicle travels within a particular geographic area or region.

For a vehicle system to request remote assistance, a communication interface (or another vehicle-based system) of the vehicle may initially transmit a request via wireless communication to one or more remote assistants positioned physically separate from the vehicle, such as a remote computing device associated with a human assistant or operator. The request for assistance may include the vehicle's location and travel plan. The request may also include sensor data (e.g., images, video, and location information) depicting the environment in near real-time and/or other information that may assist the remote assistant to provide some form of assistance to the vehicle. Further, the remote assistant may receive information about potential or predetermined situations from the vehicle or a remote source. For example, the remote assistant may receive a proposed course of action for a particular situation in addition to a live video feed taken from the vehicle. Additionally, the remote assistant may receive a graphical user interface tool template specifically designed for a particular situation.

The remote assistant may use the information received from the vehicle to determine situations in the environment that may impede the navigation and/or travel of the vehicle. For example, the remote assistant may compare locations along the travel route of the vehicle to locations of situations in the environment identified by the vehicle or a remote source. Further, the remote assistant may be configured to use the sensor data from the vehicle and potentially data from other sources (e.g., map data, GPS data, etc.) to develop navigation options for the vehicle. In some examples, the remote assistant may confirm that the vehicle's travel plan may be implemented and may provide particular changes to the travel plan to navigate potential situations along the travel route.

In some implementations, the remote assistant may be a human assistant or operator presented with a user interface configured to receive and display information from one or more systems of a vehicle. In some examples, the remote assistant may be a more powerful remote computing system, which may be capable of determining vehicle behavior in situations that may not be easily processed by the vehicle's on-board systems. In other examples, the remote assistant may be a passenger in the vehicle, which may be useful for certain intuitive behaviors that are difficult to automate (e.g., asking a taxi to move forward a few feet before dropping off passengers). Further, requests for assistance may be sent to multiple remote assistants simultaneously and/or to other types of remote assistance.

To further illustrate, a remotely positioned computing device associated with a remote assistant or operator may initially receive a request for assistance from a system of a vehicle operating in an environment. For instance, the vehicle may be autonomously navigating a neighborhood or city along a travel route and receive information about a situation in the environment from a remote source. The vehicle system may determine that remote assistance may be needed to navigate the situation and may send a request for assistance to the remote computing device. The request for assistance received by the remote computing device may indicate details related to the vehicle's navigation path. For instance, the request may specify the navigation operations to be performed along a travel route of the vehicle. Further, the request may provide information about a situation near or along the travel route of the vehicle. For example, the request may include situations in the environment that may be encountered by the vehicle within a particular time or distance.

Responsive to receiving the request from the vehicle, the remote computing device may provide an interface (e.g., a graphical user interface (GUI)) for a human assistant or operator to view and subsequently provide assistance to the vehicle. Based on input from the human assistant, the remote computing device may transmit instructions to a vehicle system for performing navigation operations. The GUI generated by the remote computing device to enable remote assistance may vary within embodiments. The GUI may be used to present the navigation operations to be performed by the vehicle to the remote operator or assistant so that the remote operator may review and provide assistance to help navigate one or more situations to be encountered along a travel path. The GUI may also display images or other sensor data (e.g., images, video, etc.) that represent the situation encountered by the vehicle. The GUI may enable the remote operator to review the sensor data obtained from the vehicle in near real-time. Further, the GUI may represent other information, such as information relating to the vehicle (e.g., location, quantity of passengers, type of vehicle, etc.).

In some examples, the GUI produced by the remote computing device may enable input from the remote operator (e.g., a human assistant). For instance, the GUI may be configured with one or more selectable options, which when selected by the remote operator, causes the remote computing device to transmit instructions to assist the vehicle in navigating a particular situation. Without such instructions from the remote operator, the vehicle's ability to modify/adjust its navigation operations may be limited. When a vehicle receives instructions from the remote computing device, the vehicle may be configured to navigate the situation based on the instructions while also monitoring the environment for changes that may require additional input from the remote operator.

When utilizing remote assistance, the system of the vehicle requesting remote assistance may utilize the remote assistant or operator to review and approve a navigation strategy. The remote assistant may also approve a navigation technique or multiple techniques to be performed by the vehicle to navigate a situation to be encountered along a travel route of the vehicle. For example, when a vehicle system proposes a strategy that involves particular types of maneuvers (e.g., crossing over the median due to construction) and/or involves temporarily reducing the safety buffer maintained around the vehicle during navigation, remote assistance may be used to review and approve (or reject) a navigation strategy prior to the vehicle performing the strategy. As such, the vehicle system may use remote assistance as a way to implement a navigation strategy that requires remote assistant approval prior to performance. In some instances, the remote assistant may review and provide alternate navigation options better suited for the vehicle to perform.

Further, the vehicle system may determine a strategy for overcoming one or more situations in the environment and responsively seek remote assistance if a confidence associated with performing the strategy is below a threshold confidence level. The vehicle system may also seek remote assistance if multiple navigation options appear to be comparatively viable to overcome a particular situation. For example, remote assistance may be used to identify an option from a plurality of options to utilize for navigation. Thus, remote assistance can enable a remote assistant to help select (or determine) a navigation strategy for the vehicle.

In some implementations, a system of a vehicle requesting remote assistance may be configured to develop and provide one or more navigation options with the request for assistance or subsequent to a connection being established between the vehicle system and the remote computing device. By developing the navigation options locally at the vehicle system, the remote assistance process may be efficiently performed and the resources required remotely by a remote assistant may be decreased. Further, when the vehicle system determines and proposes one or more navigation options for review by the remote assistant, the remote computing device can serve as the platform that provides the navigation options for the remote assistant to review and select. For example, a remote assistant (e.g., a human operator) may receive a list of two or more possible navigation options to select from for a particular situation or scenario (e.g., proceed around the obstacle on the left or on the right). The remote assistant may also be able to suggest other courses of action for the vehicle as well or instead.

The navigation options may be displayed by the remote computing device with information that helps the remote assistant understand each option. For instance, each navigation option may include a score that represents a difficulty associated with the vehicle performing one or more maneuvers to complete the navigation option. In addition, some navigation options may include indications when the navigation option includes one or more maneuvers that may require approval from a remote assistant prior to performance, such as a complex maneuver. Other indications may also be displayed with a navigation option, such as an indication where a vehicle might need to temporarily reduce its safety buffer.

In some examples, the remote computing device may display a virtual path for each navigation option that enables the vehicle to navigate along a travel route. The virtual paths may be displayed on top of a sensor representation of the environment (e.g., one or more images) or a map representation of the geographic area of the vehicle. For instance, the remote computing device may obtain sensor data and/or map data and represent each navigation option using virtual paths (e.g., color lines with arrows). As an example, a first navigation option may be displayed as an orange virtual path and a second navigation option may be displayed as a purple virtual path. The different colors can help a remote assistant differentiate during review.

In addition, the remote computing device may further divide the virtual path for each navigation option into segments where each pair of consecutive segments is separated via a checkpoint. When the autonomous vehicle is performing a navigation option, a vehicle system may be configured to transmit a progress update at each checkpoint as the vehicle navigates. In this way, a remote assistant may be able to oversee the progress as the vehicle performs the desired operation, which may also enable the remote assistant to stop the vehicle or provide other modifications to the navigation strategy in near real-time. The remote computing device may display each navigation option with an option to modify one or more parameters of the navigation option. For instance, a remote assistant may adjust a portion of the route associated with a navigation option. The computing device may also enable a remote operator to draw an operator route for the vehicle to utilize.

Example systems within the scope of the present disclosure will now be described in greater detail. An example system may be implemented in or may take the form of an automobile, but other example systems can be implemented in or take the form of other vehicles, such as cars, trucks, motorcycles, buses, boats, airplanes, helicopters, lawn mowers, earth movers, boats, snowmobiles, aircraft, recreational vehicles, amusement park vehicles, farm equipment, construction equipment, trams, golf carts, trains, trolleys, and robot devices. Other vehicles are possible as well.

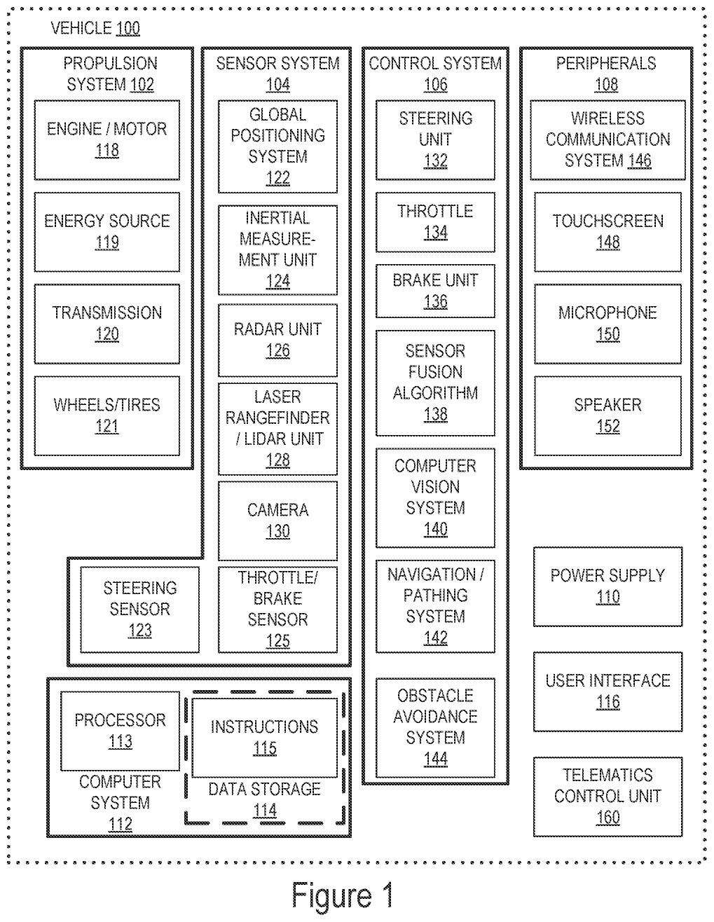

Referring now to the figures, FIG. 1 is a functional block diagram illustrating vehicle 100, which represents a vehicle capable of operating fully or partially in an autonomous mode. More specifically, vehicle 100 may operate in an autonomous mode without human interaction (or reduced human interaction) through receiving control instructions from a computing system (e.g., a vehicle control system). As part of operating in the autonomous mode, vehicle 100 may use sensors (e.g., sensor system 104) to detect and possibly identify objects of the surrounding environment to enable safe navigation. In some implementations, vehicle 100 may also include subsystems that enable a driver (or a remote operator) to control operations of vehicle 100.

As shown in FIG. 1, vehicle 100 includes various subsystems, such as propulsion system 102, sensor system 104, control system 106, one or more peripherals 108, power supply 110, computer system 112, data storage 114, and user interface 116. The subsystems and components of vehicle 100 may be interconnected in various ways (e.g., wired or secure wireless connections). In other examples, vehicle 100 may include more or fewer subsystems. In addition, the functions of vehicle 100 described herein can be divided into additional functional or physical components, or combined into fewer functional or physical components within implementations.

Propulsion system 102 may include one or more components operable to provide powered motion for vehicle 100 and can include an engine/motor 118, an energy source 119, a transmission 120, and wheels/tires 121, among other possible components. For example, engine/motor 118 may be configured to convert energy source 119 into mechanical energy and can correspond to one or a combination of an internal combustion engine, one or more electric motors, steam engine, or Stirling engine, among other possible options. For instance, in some implementations, propulsion system 102 may include multiple types of engines and/or motors, such as a gasoline engine and an electric motor.

Energy source 119 represents a source of energy that may, in full or in part, power one or more systems of vehicle 100 (e.g., engine/motor 118). For instance, energy source 119 can correspond to gasoline, diesel, other petroleum-based fuels, propane, other compressed gas-based fuels, ethanol, solar panels, batteries, and/or other sources of electrical power. In some implementations, energy source 119 may include a combination of fuel tanks, batteries, capacitors, and/or flywheel.

Transmission 120 may transmit mechanical power from the engine/motor 118 to wheels/tires 121 and/or other possible systems of vehicle 100. As such, transmission 120 may include a gearbox, a clutch, a differential, and a drive shaft, among other possible components. A drive shaft may include axles that connect to one or more wheels/tires 121.

Wheels/tires 121 of vehicle 100 may have various configurations within example implementations. For instance, vehicle 100 may exist in a unicycle, bicycle/motorcycle, tricycle, or car/truck four-wheel format, among other possible configurations. As such, wheels/tires 121 may connect to vehicle 100 in various ways and can exist in different materials, such as metal and rubber.

Sensor system 104 can include various types of sensors, such as Global Positioning System (GPS) 122, inertial measurement unit (IMU) 124, one or more radar units 126, laser rangefinder/LIDAR unit 128, camera 130, steering sensor 123, and throttle/brake sensor 125, among other possible sensors. In some implementations, sensor system 104 may also include sensors configured to monitor internal systems of the vehicle 100 (e.g., 02 monitors, fuel gauge, engine oil temperature, condition of brakes).

GPS 122 may include a transceiver operable to provide information regarding the position of vehicle 100 with respect to the Earth. IMU 124 may have a configuration that uses one or more accelerometers and/or gyroscopes and may sense position and orientation changes of vehicle 100 based on inertial acceleration. For example, IMU 124 may detect a pitch and yaw of the vehicle 100 while vehicle 100 is stationary or in motion.

Radar unit 126 may represent one or more systems configured to use radio signals to sense objects (e.g., radar signals), including the speed and heading of the objects, within the local environment of vehicle 100. As such, radar unit 126 may include one or more radar units equipped with one or more antennas configured to transmit and receive radar signals as discussed above. In some implementations, radar unit 126 may correspond to a mountable radar system configured to obtain measurements of the surrounding environment of vehicle 100. For example, radar unit 126 can include one or more radar units configured to couple to the underbody of a vehicle.

Laser rangefinder/LIDAR 128 may include one or more laser sources, a laser scanner, and one or more detectors, among other system components, and may operate in a coherent mode (e.g., using heterodyne detection) or in an incoherent detection mode. Camera 130 may include one or more devices (e.g., still camera or video camera) configured to capture images of the environment of vehicle 100.

Steering sensor 123 may sense a steering angle of vehicle 100, which may involve measuring an angle of the steering wheel or measuring an electrical signal representative of the angle of the steering wheel. In some implementations, steering sensor 123 may measure an angle of the wheels of the vehicle 100, such as detecting an angle of the wheels with respect to a forward axis of the vehicle 100. Steering sensor 123 may also be configured to measure a combination (or a subset) of the angle of the steering wheel, electrical signal representing the angle of the steering wheel, and the angle of the wheels of vehicle 100.

Throttle/brake sensor 125 may detect the position of either the throttle position or brake position of vehicle 100. For instance, throttle/brake sensor 125 may measure the angle of both the gas pedal (throttle) and brake pedal or may measure an electrical signal that could represent, for instance, the angle of the gas pedal (throttle) and/or an angle of a brake pedal. Throttle/brake sensor 125 may also measure an angle of a throttle body of vehicle 100, which may include part of the physical mechanism that provides modulation of energy source 119 to engine/motor 118 (e.g., a butterfly valve or carburetor). Additionally, throttle/brake sensor 125 may measure a pressure of one or more brake pads on a rotor of vehicle 100 or a combination (or a subset) of the angle of the gas pedal (throttle) and brake pedal, electrical signal representing the angle of the gas pedal (throttle) and brake pedal, the angle of the throttle body, and the pressure that at least one brake pad is applying to a rotor of vehicle 100. In other embodiments, throttle/brake sensor 125 may be configured to measure a pressure applied to a pedal of the vehicle, such as a throttle or brake pedal.

Control system 106 may include components configured to assist in enabling navigation by vehicle 100, such as steering unit 132, throttle 134, brake unit 136, sensor fusion algorithm 138, computer vision system 140, navigation/pathing system 142, and obstacle avoidance system 144. More specifically, steering unit 132 may be operable to adjust the heading of vehicle 100, and throttle 134 may control the operating speed of engine/motor 118 to control the acceleration of vehicle 100. Brake unit 136 may decelerate vehicle 100, which may involve using friction to decelerate wheels/tires 121. In some implementations, brake unit 136 may convert kinetic energy of wheels/tires 121 to electric current for subsequent use by a system or systems of vehicle 100.

Sensor fusion algorithm 138 may include a Kalman filter, Bayesian network, or other algorithms that can process data from sensor system 104. In some implementations, sensor fusion algorithm 138 may provide assessments based on incoming sensor data, such as evaluations of individual objects and/or features, evaluations of a particular situation, and/or evaluations of potential impacts within a given situation.

Computer vision system 140 may include hardware and software operable to process and analyze images in an effort to determine objects, environmental objects (e.g., stop lights, road way boundaries, etc.), and obstacles. As such, computer vision system 140 may use object recognition, Structure from Motion (SFM), video tracking, and other algorithms used in computer vision, for instance, to recognize objects, map an environment, track objects, estimate the speed of objects, etc.

Navigation/pathing system 142 may determine a driving path for vehicle 100, which may involve dynamically adjusting navigation during operation. As such, navigation/pathing system 142 may use data from sensor fusion algorithm 138, GPS 122, and maps, among other sources to navigate vehicle 100. Obstacle avoidance system 144 may evaluate potential obstacles based on sensor data and cause systems of vehicle 100 to avoid or otherwise negotiate the potential obstacles.

As shown in FIG. 1, vehicle 100 may also include peripherals 108, such as wireless communication system 146, touchscreen 148, microphone 150, and/or speaker 152. Peripherals 108 may provide controls or other elements for a user to interact with user interface 116. For example, touchscreen 148 may provide information to users of vehicle 100. User interface 116 may also accept input from the user via touchscreen 148. Peripherals 108 may also enable vehicle 100 to communicate with devices, such as other vehicle devices.

Wireless communication system 146 may securely and wirelessly communicate with one or more devices directly or via a communication network. For example, wireless communication system 146 could use 3G cellular communication, such as CDMA, EVDO, GSM/GPRS, or 4G cellular communication, such as WiMAX or LTE. Alternatively, wireless communication system 146 may communicate with a wireless local area network (WLAN) using WiFi or other possible connections. Wireless communication system 146 may also communicate directly with a device using an infrared link, Bluetooth, or ZigBee, for example. Other wireless protocols, such as various vehicular communication systems, are possible within the context of the disclosure. For example, wireless communication system 146 may include one or more dedicated short-range communications (DSRC) devices that could include public and/or private data communications between vehicles and/or roadside stations.

Vehicle 100 may include power supply 110 for powering components. Power supply 110 may include a rechargeable lithium-ion or lead-acid battery in some implementations. For instance, power supply 110 may include one or more batteries configured to provide electrical power. Vehicle 100 may also use other types of power supplies. In an example implementation, power supply 110 and energy source 119 may be integrated into a single energy source.

Vehicle 100 may also include computer system 112 to perform operations, such as operations described therein. As such, computer system 112 may include at least one processor 113 (which could include at least one microprocessor) operable to execute instructions 115 stored in a non-transitory computer readable medium, such as data storage 114. In some implementations, computer system 112 may represent a plurality of computing devices that may serve to control individual components or subsystems of vehicle 100 in a distributed fashion.

In some implementations, data storage 114 may contain instructions 115 (e.g., program logic) executable by processor 113 to execute various functions of vehicle 100, including those described above in connection with FIG. 1. Data storage 114 may contain additional instructions as well, including instructions to transmit data to, receive data from, interact with, and/or control one or more of propulsion system 102, sensor system 104, control system 106, and peripherals 108.

In addition to instructions 115, data storage 114 may store data such as roadway maps, path information, among other information. Such information may be used by vehicle 100 and computer system 112 during the operation of vehicle 100 in the autonomous, semi-autonomous, and/or manual modes.

Vehicle 100 may include user interface 116 for providing information to or receiving input from a user of vehicle 100. User interface 116 may control or enable control of content and/or the layout of interactive images that could be displayed on touchscreen 148. Further, user interface 116 could include one or more input/output devices within the set of peripherals 108, such as wireless communication system 146, touchscreen 148, microphone 150, and speaker 152.

Computer system 112 may control the function of vehicle 100 based on inputs received from various subsystems (e.g., propulsion system 102, sensor system 104, and control system 106), as well as from user interface 116. For example, computer system 112 may utilize input from sensor system 104 in order to estimate the output produced by propulsion system 102 and control system 106. Depending upon the embodiment, computer system 112 could be operable to monitor many aspects of vehicle 100 and its subsystems. In some embodiments, computer system 112 may disable some or all functions of the vehicle 100 based on signals received from sensor system 104.

The components of vehicle 100 could be configured to work in an interconnected fashion with other components within or outside their respective systems. For instance, in an example embodiment, camera 130 could capture a plurality of images that could represent information about a state of an environment of vehicle 100 operating in an autonomous mode. The state of the environment could include parameters of the road on which the vehicle is operating. For example, computer vision system 140 may be able to recognize the slope (grade) or other features based on the plurality of images of a roadway. Further, radar unit 126 may also provide information about the surroundings of the vehicle. Additionally, the combination of GPS 122 and the features recognized by computer vision system 140 may be used with map data stored in data storage 114 to determine specific road parameters. In other words, a combination of various sensors (which could be termed input-indication and output-indication sensors) and computer system 112 could interact to provide an indication of an input provided to control a vehicle or an indication of the surroundings of a vehicle.

In some embodiments, computer system 112 may make a determination about various objects based on data that is provided by systems other than the radio system. For example, vehicle 100 may have lasers or other optical sensors configured to sense objects in a field of view of the vehicle. Computer system 112 may use the outputs from the various sensors to determine information about objects in a field of view of the vehicle, and may determine distance and direction information to the various objects. Computer system 112 may also determine whether objects are desirable or undesirable based on the outputs from the various sensors. In addition, vehicle 100 may also include telematics control unit (TCU) 160. TCU 160 may enable vehicle connectivity and internal passenger device connectivity through one or more wireless technologies.

Although FIG. 1 shows various components of vehicle 100, i.e., wireless communication system 146, computer system 112, data storage 114, and user interface 116, as being integrated into the vehicle 100, one or more of these components could be mounted or associated separately from vehicle 100. For example, data storage 114 could, in part or in full, exist separate from vehicle 100. Thus, vehicle 100 could be provided in the form of device elements that may be located separately or together. The device elements that make up vehicle 100 could be communicatively coupled together in a wired and/or wireless fashion.

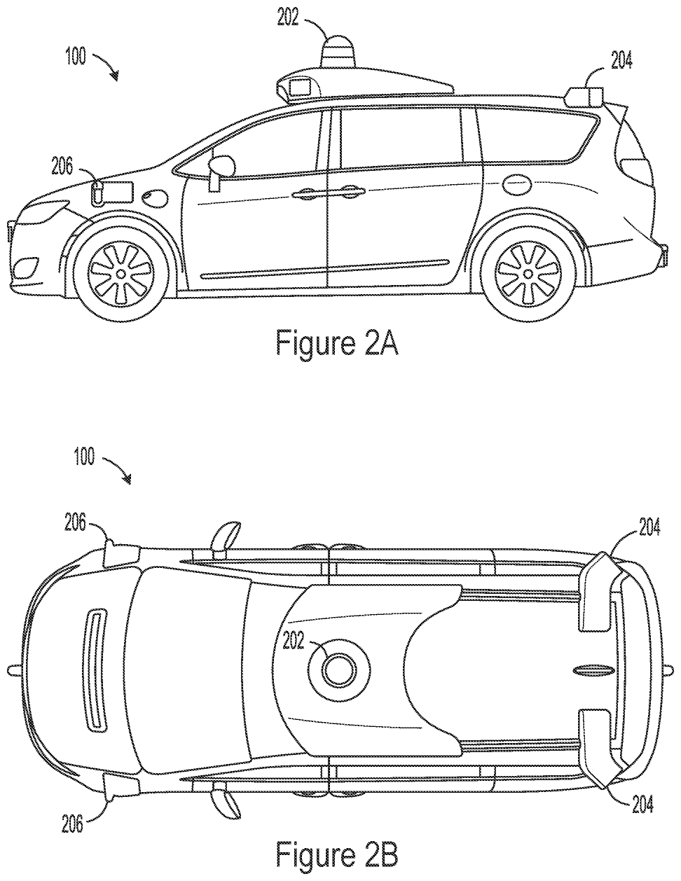

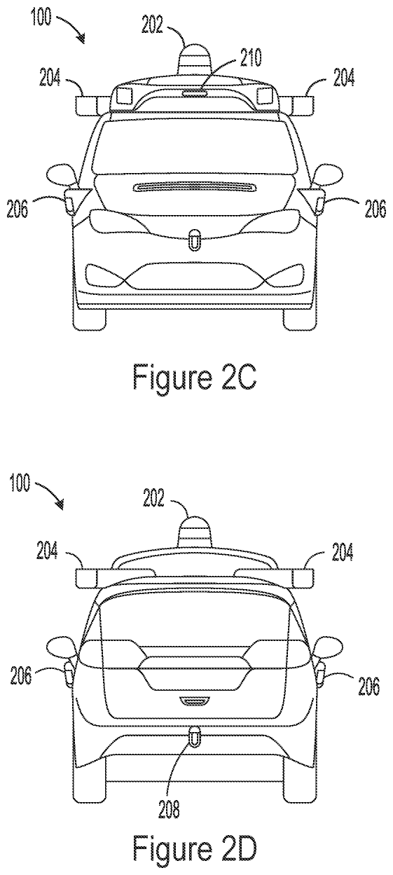

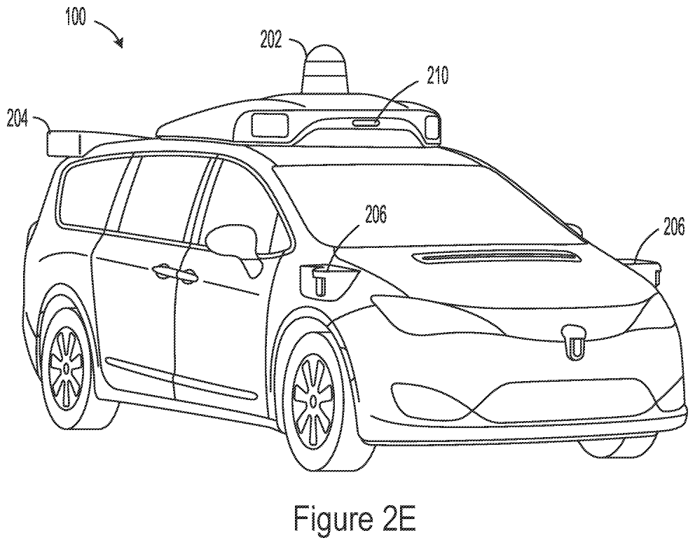

FIGS. 2A, 2B, 2C, 2D, and 2E illustrate different views of a physical configuration of vehicle 100. The various views are included to depict example sensor positions 202, 204, 206, 208, and 210 on vehicle 100. In other examples, sensors can have different positions on vehicle 100. Although vehicle 100 is depicted in FIGS. 2A-2E as a van, vehicle 100 can have other configurations within examples, such as a truck, a car, a semi-trailer truck, a motorcycle, a bus, a shuttle, a golf cart, an off-road vehicle, robotic device, or a farm vehicle, among other possible examples.

As discussed above, vehicle 100 may include sensors coupled at various exterior locations, such as sensor positions 202-210. Vehicle sensors include one or more types of sensors with each sensor configured to capture information from the surrounding environment or perform other operations (e.g., communication links, obtain overall positioning information). For example, sensor positions 202-210 may serve as locations for any combination of one or more cameras, radars, LIDARs, range finders, radio devices (e.g., Bluetooth and/or 802.11), and acoustic sensors, among other possible types of sensors.

When coupled at the example sensor positions 202-210 shown in FIGS. 2A-2E, various mechanical fasteners may be used, including permanent or non-permanent fasteners. For example, bolts, screws, clips, latches, rivets, anchors, and other types of fasteners may be used. In some examples, sensors may be coupled to the vehicle using adhesives. In further examples, sensors may be designed and built as part of the vehicle components (e.g., parts of the vehicle mirrors).

In some implementations, one or more sensors may be positioned at sensor positions 202-210 using movable mounts operable to adjust the orientation of one or more sensors. A movable mount may include a rotating platform that can rotate sensors so as to obtain information from multiple directions around vehicle 100. For instance, a sensor located at sensor position 202 may use a movable mount that enables rotation and scanning within a particular range of angles and/or azimuths. As such, vehicle 100 may include mechanical structures that enable one or more sensors to be mounted on top the roof of vehicle 100. Additionally, other mounting locations are possible within examples. In some situations, sensors coupled at these locations can provide data that can be used by a remote operator to provide assistance to vehicle 100.

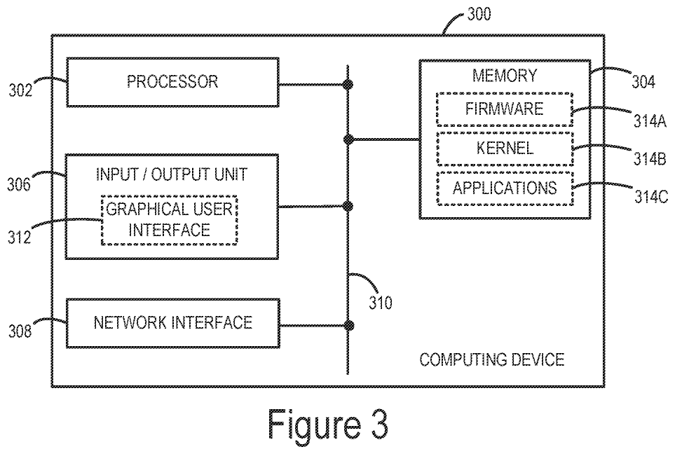

FIG. 3 is a simplified block diagram exemplifying computing device 300, illustrating some of the components that may be included in a computing device arranged to operate in accordance with the embodiments herein. Computing device 300 may be implemented as computer system 112, which may be located on vehicle 100 and perform processing operations related to vehicle operations. For example, computing device 300 may be used to process sensor data received from sensor system 104. Alternatively, computing device 300 may be located remotely from vehicle 100 and communicate via secure wireless communication. For example, computing device 300 may operate as a remotely positioned device that a remote human operator can use to communicate with one or more vehicles.

In the example embodiment shown in FIG. 3, computing device 300 includes processor or processing system 302, memory 304, input/output unit 306, and network interface 308, all of which may be coupled by a system bus 310 or a similar mechanism. Additionally or alternatively, computing device 300 may communicate with other devices using a universal serial bus (USB) or high-definition multimedia interface (HDMI) port interface, for example. In some embodiments, computing device 300 may include other components and/or peripheral devices (e.g., detachable storage, sensors, and so on).

Processor 302 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 302 may be one or more single-core processors. In other cases, processor 302 may be one or more multi-core processors with multiple independent processing units. Processor 302 may also include register memory for temporarily storing instructions being executed and related data, as well as cache memory for temporarily storing recently-used instructions and data.

Memory 304 may store program instructions and/or data on which program instructions may operate. By way of example, memory 304 may store these program instructions on a non-transitory, computer-readable medium, such that the instructions are executable by processor 302 to carry out any of the methods, processes, or operations disclosed in this specification or the accompanying drawings. Memory 304 may be any form of computer-usable memory, including but not limited to random access memory (RAM), read-only memory (ROM), and non-volatile memory. This may include flash memory, hard disk drives, solid state drives, rewritable compact discs (CDs), rewritable digital video discs (DVDs), and/or tape storage, as just a few examples. Further, memory 304 may include fixed memory as well as one or more removable memory units, the latter including but not limited to various types of secure digital (SD) cards. Thus, memory 304 can represent both main memory units, as well as long-term storage. Other types of memory may include biological memory.

As shown in FIG. 3, memory 304 may include firmware 314A, kernel 314B, and/or applications 314C. Firmware 314A may be program code used to boot or otherwise initiate some or all of computing device 300. Kernel 314B may be an operating system, including modules for memory management, scheduling and management of processes, input/output, and communication. Kernel 314B may also include device drivers that allow the operating system to communicate with the hardware modules (e.g., memory units, networking interfaces, ports, and busses), of computing device 300. Applications 314C may be one or more user-space software programs, such as web browsers or email clients, as well as any software libraries used by these programs. In some examples, applications 314C may include one or more neural network applications and other deep learning-based applications. Memory 304 may also store data used by these and other programs and applications.

Input/output unit 306 may facilitate user and peripheral device interaction with computing device 300 and/or other computing systems. Input/output unit 306 may include one or more types of input devices, such as a keyboard, a mouse, one or more touch screens, sensors, biometric sensors, and so on. Similarly, input/output unit 306 may include one or more types of output devices, such as a screen, monitor, printer, speakers, and/or one or more light emitting diodes (LEDs). In some examples, input/output unit 306 can be configured to receive data from other devices. For instance, input/output unit 306 may receive sensor data from vehicle sensors.

As shown in FIG. 3, input/output unit 306 includes graphical user interface (GUI) 312, which may be configured to provide information to an operator or another user. GUI 312 may be displayable one or more display interfaces, or another type of mechanism for conveying information and receiving inputs. In some examples, the representation of GUI 312 may differ depending on a vehicle situation. For example, computing device 300 may provide GUI 312 in a particular format, such as a format with a single selectable option for a remote operator to select from.

Network interface 308 may take the form of one or more wireline interfaces, such as Ethernet (e.g., Fast Ethernet, Gigabit Ethernet, and so on). Network interface 308 may also support communication over one or more non-Ethernet media, such as coaxial cables or power lines, or over wide-area media, such as Synchronous Optical Networking (SONET) or digital subscriber line (DSL) technologies. Network interface 308 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 308. Furthermore, network interface 308 may comprise multiple physical interfaces. For instance, some embodiments of computing device 300 may include Ethernet, BLUETOOTH®, and Wifi interfaces. In some embodiments, network interface 308 may enable computing device 300 to connect with one or more vehicles to allow for remote assistance techniques presented herein.

Referring still to FIG. 3, computing device 300 may be configured to generate a navigation strategy for a vehicle (e.g., vehicle 100) to navigate in an environment. Further, computing device 300 may generate a request to obtain remote assistance (e.g., a human assistant and/or a computing assistant) that may help resolve a variety of situations that a human driver would typically be able to overcome. For example, remote assistance may be used to help computing device 300 in various ways, such as determining a travel route, avoiding obstacles, monitoring performance of a route, adjusting of a navigation route, confirming or denying navigation options or maneuvers proposed by a vehicle navigation system, checking on passengers, and/or performing other forms of remote assistance.

When computing device 300 determines that the vehicle may encounter a situation along a travel route where navigation progress may be impeded in some way (e.g., by an obstacle, a narrow passageway, an accident, road construction, a road condition, a traffic condition, etc.), computing device 300 may obtain remote assistance (e.g., human input) that may help the vehicle effectively overcome the situation. For example, computing device 300 may determine potential or predetermined conditions or situations near or along a travel route that may require remote assistance. The predestined condition may be determined based on historical or previous data that occurred along the travel route. Once computing system 300 determines a predetermined situation, computing device 300 may request remote assistance to help the computing device 300 navigate the situation. Computing device 300 may obtain information about the situation or issue in the environment from a remote source (e.g., a map system, a GPS system, an assistance center, a fleet management system, etc.). In some examples, the remote source and/or computing device 300 may obtain information about the situation (e.g., an obstacle, a road or traffic condition, etc.) in the environment from other vehicles and/or remote assistants. Further, the remote assistant may receive a graphical user interface tool template specifically designed for a particular situation. For example, a construction site may have an associated template that may enable a remote assistant to review and provide assistance to a vehicle approaching the situation.

The remote source may notify computing device 300 about the situation or condition in the environment. The remote source may identify the situation in the environment after receiving a particular number of reports or notifications about the situation within a threshold time from one or more vehicles. For instance, when two or more vehicles experience the situation or condition at a particular route location due to a road or traffic condition, one or more systems of the vehicle may notify a remote source (e.g., a map system, a GPS system, a fleet management system, an assistance center, remote assistance, etc.) about the situation. Once the remote source receives the information about the situation, the remote source may notify or inform computing device 300 about the situation.

In some embodiments, the remote source may compile information about the current state of various driving conditions or situations within a geographic area (e.g., road blockages, construction, traffic, etc.). For example, the remote source may maintain a persistent, time-ordered database of information about the conditions or situations by combining data or information (e.g., reports) from individual vehicles in the environment. The vehicles may be autonomously detecting possible issues or situations within the environment and generating information to send back to the remote source. The vehicles may send sensor data collected from the environment along with the information about situations encountered by the vehicles. Further, computing device 300 may be configured to send information to the remote source about situations encountered in the environment by the vehicles.

The remote source may validate the incoming information received from vehicles in the environment (e.g., within a fleet or geographic area). The information may need to be validated before sending it out to other vehicles in order to send accurate information to the vehicles in the environment. The information may be validated by comparing the information to sensor data collected by the vehicle sending the information and/or by other vehicles in the same area in order to confirm the accuracy of the information. In some examples, the information may be validated by a human assistant or operator. Further, the remote source may be able to deploy vehicles to a particular area to validate the information about the conditions or situations.

The remote source may associate a confidence metric with the information about the situations. In some examples, the remote source may require a certain level of confidence for information about the situation before validating the information and adding the situation to the database. The level of validation required for particular information may be determined based on the confidence metric associated with the information. For instance, particular information about a situation with a high confidence metric (e.g., above a predefined threshold level) may be automatically validated without further processing. In other examples, receiving similar information a certain number of times may be required before particular information is trusted or validated. For example, a report or notification about a situation may be validated after a certain number of similar reports about the situations are received within a certain time period (confirming that the reports are likely to be accurate). In further examples, the level of confidence required to validate particular information may be determined in part based on the importance of the information. For instance, information relating to a high traffic or highly populated area may require greater confidence to be validated. Also, information relating to more important road conditions (e.g., a total blockage requiring vehicle re-routing) also may require higher confidence for validation.

The remote source also may periodically update the information by removing outdated information as new information becomes available. For example, the remote source may remove situations from the database after a particular number of vehicles successfully navigate along a travel route without encountering the situation. Further, particular information may only be relevant for decision making by vehicles within the environment for a certain period of time. For instance, a reported lane blockage resulting from an accident may only be important for a short period of time until the blockage is cleared by emergency crews. At that point, some or all of the information may be removed from the database.

In some examples, the remote source may assign certain information a particular timeout value after which the information may be removed from the database. For instance, a parade may be identified which is blocking certain roads currently, but may be scheduled to end within a certain amount of time. Accordingly, the information can be removed from the database of the remote source after the appropriate amount of time has passed (possibly with some buffer built in and/or after some external validation has been received, such as from a human in the area or another vehicle). Other types of information that may be assigned timeout periods may include road blockages from concerts or sporting events, construction areas, or weather conditions (perhaps with less confidence or requiring further validation). Other types of information may need to be stored for an indefinite time period. For instance, it may not be possible to predict when a blockage resulting from an accident will be completely cleared Such information may only be removed when a vehicle in the environment or different information confirms that the obstruction has been cleared.

The remote source may provide the information to vehicles in the environment. For instance, a vehicle may receive information about potential or predetermined situations within a certain radius of its current location or within a certain radius of its planned route or routes. In some examples, vehicles that are part of a fleet or within a geographic area may receive the information. The vehicles may use the information to identify the situations and route around them or determine other ways to avoid or handle them. In some embodiments, the vehicle may request remote assistance to help navigate the situation.

Further, the remote source may also contain proposed courses of action for vehicles to take in dealing with identified situations or conditions (e.g., road or traffic events). The proposed courses of action may have been determined to work by other vehicles and/or by human operators. For instance, a human operator may receive and validate information about a situation in the environment and provide instructions to a particular vehicle. The instructions may then be provided to other vehicles encountering the same situation at the same location. Other information may be stored and/or transmitted in some examples as well.

Once computing device 300 of a vehicle receives the information about the situations from the remote source, computing device 300 may determine or identify the situations in the environment. Computing device 300 may determine a strategy for overcoming the situations encountered along the travel route and may responsively seek remote assistance. In some examples, computing device 300 may request remote assistance before the vehicle reaches or encounters the situation. Computing device 300 may use the information about the situation to develop a trigger for requesting remote assistance before the vehicle encounters the situation. For example, a remote assistance process may be triggered in response to computing device 300 identifying the situation along the travel route of a vehicle. In some examples, computing device 300 of the vehicle may be triggered to request remote assistance when the vehicle is within a particular distance from the situation on the travel route. Computing device 300 may also be triggered to request remote assistance when the vehicle travels within a particular geographic area or region. Further, computing device 300 may request remote assistance for a predetermined situation if a confidence associated with navigating the situation is below a threshold confidence level.

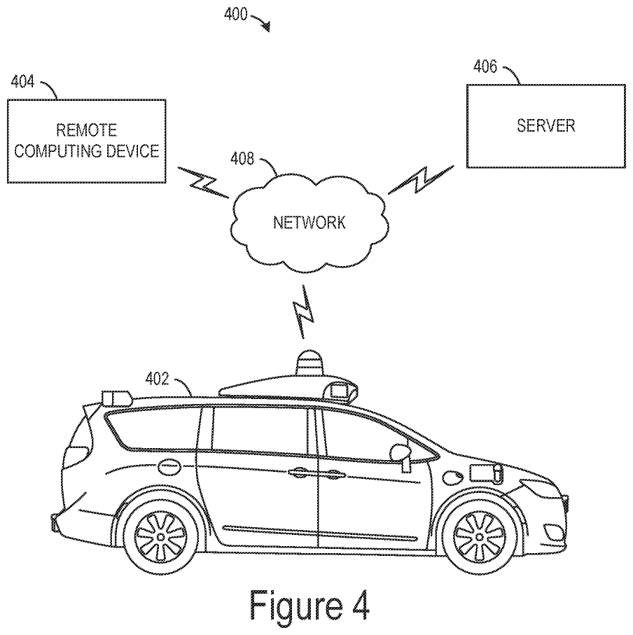

FIG. 4 is a system for wireless communication between computing devices and a vehicle, according to one or more example embodiments. System 400 may enable vehicles (e.g., vehicle 402) to obtain remote assistance from remote assistants (e.g., human operators) using computing devices positioned remotely from the vehicles (e.g., remote computing device 404). Particularly, system 400 is shown with vehicle 402, remote computing device 404, and server 406 communicating wirelessly via network 408. System 400 may include other components not shown within other embodiments, such as firewalls and multiple networks, among others.

Vehicle 402 may transport passengers or objects between locations, and may take the form of any one or more of the vehicles discussed above, including passenger vehicles, cargo shipping vehicles, farming and manufacturing vehicles, and dual-purpose vehicles. When operating in an autonomous mode (or semi-autonomous mode), vehicle 402 may navigate to pick up and drop off passengers (or cargo) between desired destinations. In some embodiments, vehicle 402 can operate as part of a fleet of vehicles, such as within a fleet of ride-share vehicles.

Remote computing device 404 may represent any type of device related to enabling remote assistance techniques, including but not limited to those described herein. Within examples, remote computing device 404 may represent any type of device configured to (i) receive information related to vehicle 402, (ii) provide an interface (e.g., a GUI, physical input interfaces) through which a human operator can in turn perceive the information and input a response related to the information, and (iii) transmit the response to vehicle 402 or to other devices (e.g., storage at server 406). As such, remote computing device 404 may take various forms, such as a workstation, a desktop computer, a laptop, a tablet, a mobile phone (e.g., a smart phone), a wearable device (e.g., a headset) and/or a server. In some examples, remote computing device 404 may include multiple computing devices operating together in a network configuration. In further embodiments, remote computing device 404 may resemble a vehicle simulation center with the remote operator positioned as the drive of the simulation center. In addition, remote computing device 404 may operate as a head mountable device that can simulate the perspective of vehicle 402.

The position of remote computing device 404 relative to vehicle 402 can vary within examples. For instance, remote computing device 404 may have a remote position from vehicle 402, such as operating inside a physical building. In another example, remote computing device 404 may be physically separate from vehicle 402, but operate inside vehicle 402 to enable a passenger of vehicle 402 to act as the human operator. For instance, remote computing device 404 may be a touchscreen device operably by a passenger of vehicle 402. Operations described herein that are performed by remote computing device 404 may be additionally or alternatively performed by vehicle 402 (i.e., by any system(s) or subsystem(s) of vehicle 100). In other words, vehicle 402 may be configured to provide a remote assistance mechanism with which a driver or passenger of the vehicle can interact.

Operations described herein may be performed by any of the components communicating via network 408. For instance, remote computing device 404 may determine remote assist options for a human operator to review based on different levels of information provided by vehicle 402. In some embodiments, vehicle 402 may determine potential navigation options for remote computing device 404 to display for a remote operator to review. Potential options could include routes, vehicle movements, and other navigation parameters for review by remote computing device 404 and/or a remote operator using remote computing device 404.

In other embodiments, remote computing device 404 may analyze sensor data or other information from vehicle 402 to determine the situation and potential options for a remote operator to review. For instance, remote computing device 404 may determine a route and/or operations for vehicle 402 to execute using information from vehicle 402 and/or other external sources (e.g., server 406). In some embodiments, remote computing device 404 may generate a GUI to display one or more selectable options for review by a remote operator.

Server 406 may be configured to wirelessly communicate with remote computing device 404 and vehicle 402 via network 408 (or perhaps directly with remote computing device 404 and/or vehicle 402). As such, server 406 may represent any computing device configured to receive, store, determine, and/or send information relating to vehicle 402 and the remote assistance thereof. As such, server 406 may be configured to perform any operation(s), or portions of such operation(s), that is/are described herein as performed by remote computing system 404 and/or vehicle 402. Some implementations of wireless communication related to remote assistance may utilize server 406, while others may not.

Network 408 represents infrastructure that may enable wireless communication between computing devices, such as vehicle 402, remote computing device 404, and server 406. For example, network 408 can correspond to a wireless communication network, such as the Internet or a cellular wireless communication network. The various systems described above may perform various operations. These operations and related features will now be described.

In some examples, a remote computing system (e.g., remote computing device 404 or server 406) may operate in one of two modes. The first of these modes may serve, in essence, as a means for a human operator (of the vehicle and/or the remote computing system) to provide remote assistance support for the vehicle. The remote computing system may enable a human operator to provide this support in near real-time or less frequently than real-time.

The second of these two modes may serve, at a minimum, as a means for keeping the human operator alert. The human operator may be a passenger or driver of the vehicle, or may be a third party located remotely from the vehicle but tasked with the responsibility of providing remote assistance to the vehicle (and possibly to other vehicles as well). Regardless of who the human operator is, it is desirable to keep the human operator alert so that the human operator can provide optimal remote assistance with minimal delay.

For instance, there may be scenarios in which the vehicle may not have requested remote assistance in a certain amount of time (e.g., one hour), and therefore the human operator tasked with providing remote assistance to the vehicle may not have taken any remote assistance action in that amount of time, which may be long enough where the human operator may become fatigued or otherwise less attentive than desirable. In these and other types of possible scenarios, it may be desirable to periodically prompt the human operator during this time, via the remote computing system, with alertness data to keep them alert. The alertness data may take various forms, such as archived images, audio, or video having confirmed or unconfirmed object identifications, also including generated natural-language questions regarding the confirmed or unconfirmed object identifications.

Remote assistance tasks may also include the human operator providing an instruction to control operation of the vehicle (e.g., instruct the vehicle to travel to a particular destination associated with an identified passenger). In some scenarios, the vehicle itself may control its own operation based on the human operator's feedback related to the identification of the situation or condition (e.g., an obstacle). For instance, upon receiving a confirmation that the occupancy of the vehicle meets a desired occupancy, the vehicle control system may cause the vehicle to safely transport the passengers to a requested destination. In some examples, a remote operator can enable a vehicle to temporarily perform one or more operations to resolve a situation that the vehicle may normally not be permitted to perform. For instance, remote computing device 404 may be used to enable vehicle 402 to back up, navigate with a decreased buffer zone, or travel in a zone that is usually off limits (e.g., over the median or use a driveway).

In some embodiments, remote assistance for vehicles may originate from a network of remote operators. For example, a vehicle may submit a request for assistance that is received at an entry point of the network. The entry point may connect the request with a remote operator that can provide assistance. The remote operator may be selected based on credentials associated with the remote operator that indicate that he or she may be able to handle the type of assistance that is being requested and/or the operator's availability, among other potential parameters. The entry point may analyze information within the request to route requests for assistance accordingly. For example, the network of remote operators may be used to provide assistance to an entire fleet of autonomous vehicles.

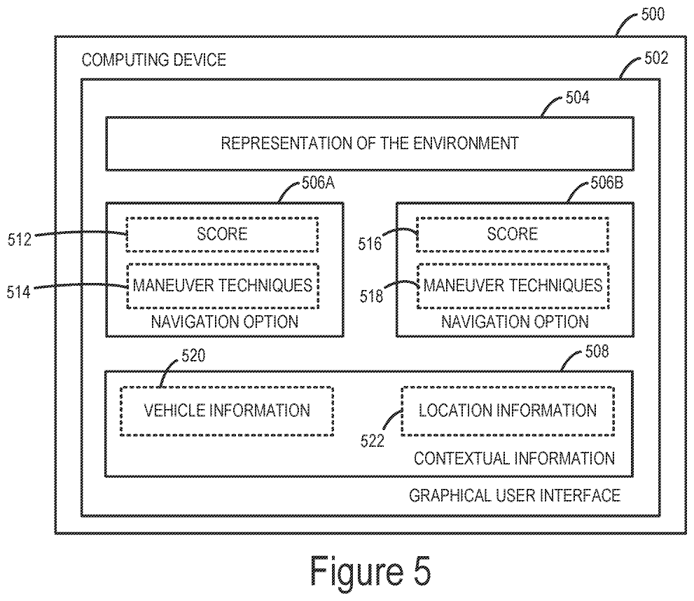

FIG. 5 illustrates a computing device displaying a GUI for enabling remote assistance to a vehicle, according to one or more example embodiments. In the example embodiment, computing device 500 is displaying GUI 502, which may include a representation of the environment 504, navigation option 506A, navigation option 506B, and contextual information 508. In other embodiments, GUI 502 may include more or less elements in other potential arrangements.

GUI 502 may represent a system of interactive visual components for computer software. As such, GUI 502 may be used to display objects that convey information to a remote operator and also represent actions that may be taken by the remote operator. Computing device 500 may generate GUI 502 based on templates enabling an available remote operator to quickly review and provide assistance to a vehicle. In addition, computing device 500 may display GUI 502 on a display interface, such as a touch screen or external monitor. In other examples, computing device 500 may display GUI 502 or elements from GUI 502 via a display interface associated with a head-mounted wearable computing device (e.g., augmented reality).

Computing device 500 may use GUI 502 to enable interaction between a human operator and vehicles that request assistance. The human operator may provide inputs to computing device 500 via touch inputs, buttons or hardware inputs, motion and vocal inputs. For example, computing device 500 may include a microphone to receive vocal inputs and use speech recognition software to derive operations based on the vocal inputs from the operator. In some examples, computing device 500 may resemble a vehicle emulator that enables a human operator to experience a simulation that mimics the vehicle's perspective.

Representation of the environment 504 is an object displayable via GUI 502 that may represent the current environment (or recent environment) from the perspective of the vehicle. By displaying representation of the environment 504, a remote operator may review a sensor perspective of the environment as captured by vehicle sensors. For instance, representation of the environment 504 may display images and/or video of the environment as captured by vehicle cameras. In other instances, sensor data from different types of sensors may be used to generate and provide representation of the environment 504 via GUI 502. For instance, representation of the environment 504 may include a point cloud developed using radar and/or LIDAR. As such, representation of the environment 504 may show the positions of obstacles or other environment elements (e.g., situations or conditions) that may have disrupted the path of travel of the vehicle that is requesting assistance. For example, representation of the environment 504 may depict the road, other vehicles, pedestrians, bicycles, traffic signals and signs, road elements, and other features within the vehicle's environment.

In some examples, representation of the environment 504 may depict the vehicle's environment in real-time. For example, vehicle sensors (e.g., cameras) may capture and provide sensor data (e.g., images) of the environment in near real-time to computing device 500 enabling a human operator to observe the current state of the vehicle's environment.

Computing device 500 may use visual indicators, such as arrows, boxes, or a combination to highlight aspects of the environment, such as the obstacles blocking the path of travel of the vehicle. For example, computing device 500 may use computer vision to detect elements within images and identify elements using different colors, such as red boxes to identify pedestrians, blue boxes for other vehicles, and green boxes for stationary objects.

Computing device 500 may further obtain map data based on a location of the vehicle. For instance, the vehicle may provide GPS measurements or another indication of the vehicle's location within a request for assistance or during subsequent communication between the vehicle and computing device 500. By using the vehicle's location, computing device 500 may acquire map data and further enhance the information included within representation of the environment 504 and/or other objects displayed via GUI 502. For example, computing device 500 may determine and display representation of environment 504 as an elevated view of the vehicle and nearby surroundings estimated based on the map data and the sensor data from the vehicle. In some examples, GUI 502 may include both a sensor perspective of the vehicle's environment and the elevated view estimated based on one or both of the sensor data and map data.

Navigation options 506A, 506B represent different strategies that may be displayed by GUI 502. A human operator may review and select navigation option 506A or navigation option 506B to cause computing device 500 to relay instructions to the vehicle to perform. In particular, the vehicle may receive the instructions from computing device 500 and perform the selected navigation option while monitoring for changes in the environment that may require modifying or stopping performance of the selected navigation option. For instance, while performing the selected remote assistance strategy (e.g., navigation option 506A), the vehicle may detect the presence of another vehicle or pedestrian that may alter the performance of the remote assistance strategy.

In the embodiment shown in FIG. 5, GUI 502 shows two navigation options (i.e., navigation options 506A, 506B). In some instances, GUI 502 may show only one navigation option or more than two navigation options. The number of navigation options may depend on the situation that the vehicle is involved in when requesting assistance. In some examples, the number of navigation options may also be limited to potentially decrease the amount of time that the human operator uses to provide options. For example, a high number of navigation options (e.g., 4 or more) may take too much time to review. In addition, the quality of the proposed navigation options may decrease as the quantity increases. In some examples, the GUI may be configured to only display the best navigation options based on sensor data measuring the environment.

In some examples, computing device 500 may receive a request for assistance that does not include any proposed navigation options. Computing device 500 may display GUI 502 with an indication that the vehicle systems are requesting the human operator to develop and provide a navigation strategy to the vehicle to perform. The navigation strategy may specify a route that starts at the vehicle's current location and involves a target path to continue navigation to a target destination. GUI 502 may enable a human operator to adjust existing navigation options or provide custom navigation strategies developed by the human operator.

In some examples, navigation options 506A, 506B may be displayed in a visual representation that enables quick review by a human operator. For instance, navigation options 506A, 506B may be depicted as virtual paths on representation of the environment 504. Displaying navigation options 506A, 506B as virtual paths on representation of the environment 504 may be beneficial for when a vehicle is attempting to circumvent or exit a situation quickly. For example, when the vehicle is trying to navigate a parking lot or around construction or an accident, GUI 502 may show one or more navigation options as virtual paths or using other symbols on images, video, or other sensor data representing the area surrounding the vehicle. This technique can enable a human operator to closely review the environment of the vehicle and to provide useful remote assistance based on a clear understanding of the environment.

In some examples, GUI 502 may display multiple navigation options (e.g., both navigation option 506A and navigation option 506B) together to enable a human operator to review and compare. For example, GUI 502 may display a route for navigation option 506A as a blue-color virtual path and a route for navigation option 506B as a red-color virtual path on representation of the environment 504. In some instances, GUI 502 may be configured to display only a single navigation option at a time to avoid confusion. In addition, computing device 500 may obtain map data for the vehicle's current location and display the routes for each navigation option 506A, 506B using the map data. For instance, map data may be used to display navigation strategies that may involve a significant detour or substantial travel distance overall (e.g., more than half a mile or another threshold distance).

In some examples, a virtual path may be displayed in an augmented reality via images and/or video data received by computing device 500 of the vehicle in near real-time. Particularly, the human operator may watch and monitor the vehicle's environment using video, images, or other sensor data from the vehicle as the vehicle awaits and receives remote assistance. For example, GUI 502 can display the images or video received from the vehicle in near real-time to enable the human operator to provide continuous assistance to the vehicle. The human operator can adjust the vehicle's route or maneuvers as the vehicle navigates.

In some examples, the virtual paths for navigation options 506A, 506B can be further divided and displayed as segments with checkpoints between consecutive segments. The vehicle may be configured to provide an update at each checkpoint to computing device 500. In some instances, the vehicle may be configured to temporarily stop at each checkpoint (or a subset of the checkpoints). Computing device 500 may be configured to provide a status update or other information to the human operator at each checkpoint. In addition, the human operator may provide updates to the navigation path at a checkpoint.

GUI 502 may also enable the remote operator to provide a custom navigation option (e.g., drawing a desired path on map data or representation of environment 504). GUI 502 may also display an option to modify one or more parameters for each navigation option 506A, 506B. Further, the GUI may display a graphical user interface tool template specifically designed for a particular situation. For example, a construction site may have an associated template that may enable a remote operator to review and provide assistance to a vehicle approaching the situation.

In the embodiment shown in FIG. 5, each navigation option 506A, 506B may be displayed with additional information developed to assist the human operator review, such as score 512 and score 516, respectively. Scores 512, 516 may be determined by the vehicle based on parameters associated with performing each navigation option 506A, 506B. For example, when a navigation option requires performance of one or more complex maneuvers (e.g., reversing, U-turn), disfavored maneuvers, and/or reducing the vehicle's safety buffer maintained around the vehicle, the corresponding score may be lower relative to a navigation option that does not include the complex maneuvers. Scores 512, 516 can also depend on the time to complete each navigation option 506A, 506B, respectively.

As shown in FIG. 5, each navigation option 506A, 506B may also indicate maneuver techniques 514, 518, respectively. Maneuver techniques 514, 518 may convey one or more maneuvers that the vehicle will perform should a particular navigation option be selected. For example, navigation option 506A may include a U-turn, which is represented by maneuver technique 514 as a description (e.g. “U-turn here”) or a visual representation. In some examples, only maneuver techniques that require human operator approval prior to performance may be represented via maneuver techniques 514, 518.

GUI 502 may also include contextual information 508, which may convey additional information to supplement a remote operator's understanding of the vehicle's situation. As shown in FIG. 5, contextual information 508 includes vehicle information 510 and location information 522. Vehicle information 520 may indicate a variety of information about the vehicle, such as the type of vehicle, the vehicle sensors on the vehicle, the quantity of the passengers, and target destination, etc. Location information 522 may represent information based on the current location of the vehicle, such as map data depicting the environment. Contextual information 508 may also specify information related to the situation, such as how long has the vehicle been stranded and a reason proposed by the vehicle for the stranding.

Referring still to FIG. 5, computing device 500 may obtain information about potential or predetermined situations (e.g., obstacles, road conditions, etc.) from vehicles operating in the environment and/or provide the information to the vehicles in the environment. For example, the vehicles navigating in the environment may detect possible issues or situations within the environment and may generate information to send back to computing device 500. The vehicles may send sensor data collected from the environment along with the information about the situations encountered by the vehicles. Computing device 500 may compile information about the current state of various driving conditions or situations within a geographic area (e.g, road blockages, construction, traffic, etc.). In some examples, computing device 500 may maintain a persistent, time-ordered database of information about the conditions or situations by combining data or information (e.g., reports) from individual vehicles in the environment Once the computing device 500 receives the information, the computing device 500 may be configured to provide notifications to the other vehicles in the environment about the situation.

Computing device 500 of the vehicle may validate the incoming information received from the vehicles in the environment (e.g., within a fleet or geographic area). The information may need to be validated before sending it out to other vehicles in order to ensure accurate information may be sent to the vehicles in the environment. In some examples, computing device 500 may also validate the information about a situation when the computing device 500 receives a particular number of reports or notifications about the situation within a threshold time from one or more vehicles in the environment. Computing device 500 may be able to deploy vehicles to a particular area to validate the information about the situation. In some examples, computing device 500 may validate the information by comparing the information to sensor data collected by the vehicle sending the information and/or by other vehicles in the same area in order to confirm the accuracy of the information. In other examples, the information may be validated by a human assistant or operator.

Computing device 500 may associate a confidence metric with the information about the situations in the environment. In some examples, computing device 500 may require a certain level of confidence about the information before validating the information and adding the situation to the database. The level of validation required for particular information may be determined based on the confidence metric associated with the information. For instance, particular information about a situation with a high confidence metric (e.g., above a predefined threshold level) may be automatically validated by computing device 500 without further processing. In other examples, receiving similar information a certain number of times by the computing device 500 of the vehicle may be required before particular information is tmsted or validated. For example, a report or notification about a situation from a vehicle may be validated by computing device 500 after a certain number of similar reports about the situations are received within a certain time period (confirming that the reports are likely to be accurate). In further examples, the level of confidence required to validate particular information may be determined in part based on the importance of the information. For instance, information relating to a high traffic or highly populated area may require greater confidence to be validated. Also, information relating to more important road conditions (e.g, a total blockage requiring vehicle re-routing) also may require higher confidence for validation.

Further, computing device 500 may periodically update the information about the situations or conditions in the environment by removing outdated information as new information becomes available. For example, computing device 500 may remove situations from the database after a particular number of vehicles successfully navigate along a travel route without encountering the situation. In some examples, particular information may only be relevant for decision making by vehicles within the environment for a certain period of time. For instance, a reported lane blockage resulting from an accident may only be important for a short period of time until the blockage is cleared by emergency crews. At that point, some or all of the information may be removed from the database.

In some examples, computing device 500 may assign certain information a particular timeout value after which the information may be removed from the database. For instance, a parade may be identified which is blocking certain roads currently, but may be scheduled to end within a certain amount of time. As such, information can be removed from the database by the computing device 500 after the appropriate amount of time has passed (possibly with some buffer built in and/or after some external validation has been received, such as from a human in the area or another vehicle). Other types of information that may be assigned timeout periods may include road blockages from concerts or sporting events, construction areas, or weather conditions (perhaps with less confidence or requiring further validation). Other types of information may need to be stored for an indefinite time period. For instance, it may not be possible to predict when a blockage resulting from an accident will be completely cleared Such information may only be removed when a vehicle in the environment or different information confirms that the obstruction has been cleared.

Once computing device 500 determines the situations or conditions in the environment, computing device 500 may provide the information about the situations to the vehicles operating in the environment. For instance, computing device 500 may notify vehicles in the environment when the vehicles travel within a particular distance of the location of the situation. In some examples, a vehicle may receive information of situations within a certain radius of its current location or within a certain radius of its planned route or routes. Further, vehicles that are part of a fleet or within a geographic area may receive the information. The vehicles may use the information to identify the situations and route around them or determine other ways to avoid or handle them.

Computing device 500 may receive a request for remote assistance from a vehicle before the vehicle reaches or encounters the situation. The situation may be determined based on historical or previous data that occurred in the environment. In some examples, computing device 500 may provide proposed courses of action for a vehicle to take in dealing with the situation or condition (e.g., road or traffic events). The proposed courses of action may have been determined to work by other vehicles and/or by human operators. For instance, a human operator may receive and validate information about vehicles navigating the situation in the environment using instructions provided to the vehicle by computing device 500. The instructions may then be provided to other vehicles encountering the same situation at the same location. Other information may be stored and/or transmitted in some examples as well.

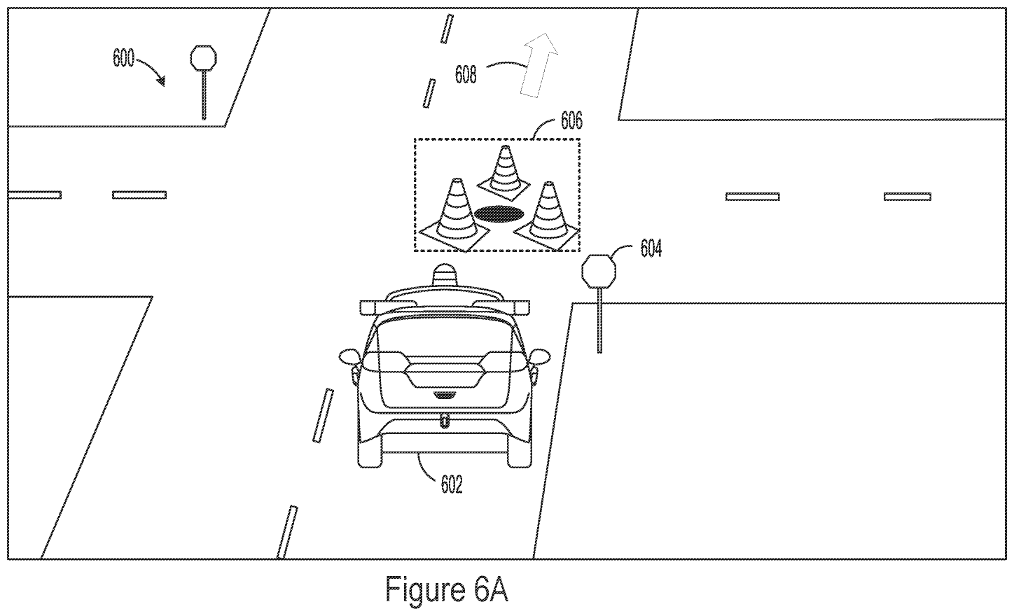

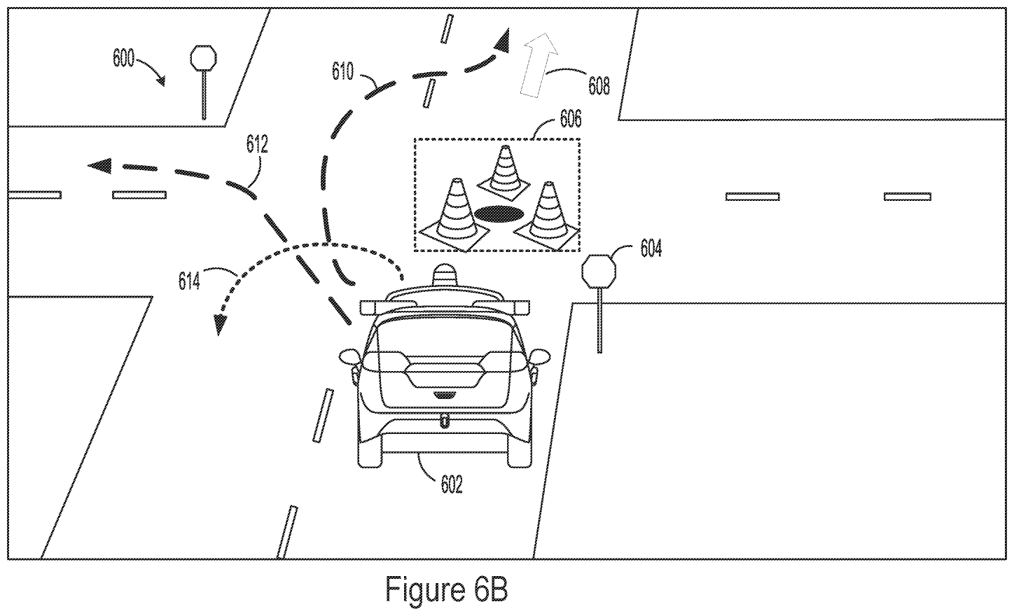

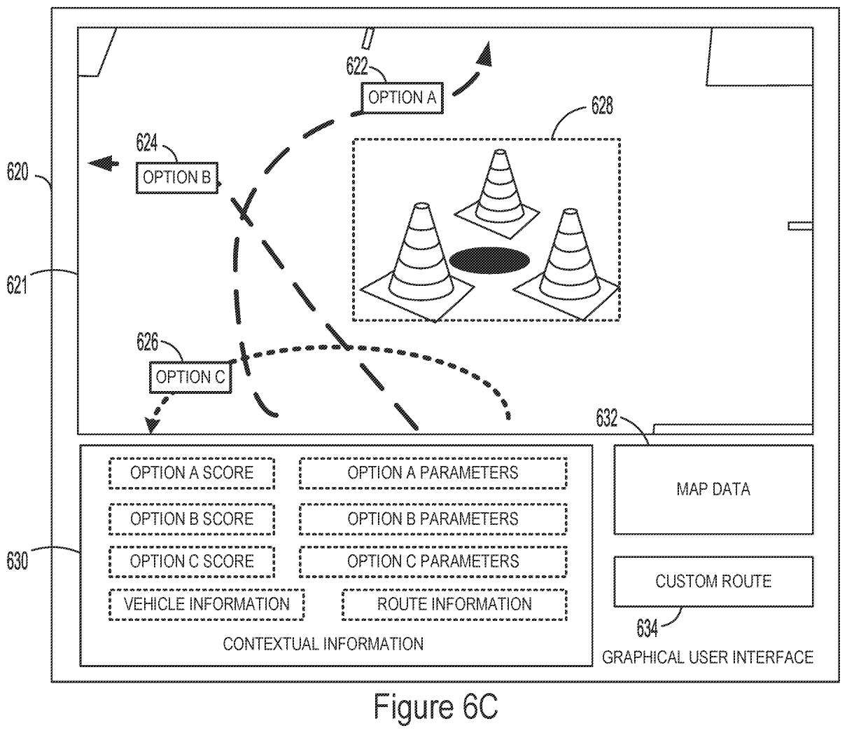

FIGS. 6A, 6B, 6C illustrate a scenario encountered by an autonomous vehicle, according to one or more example embodiments. In FIG. 6A, scenario 600 is shown with an environment perspective from the view point from behind vehicle 602. Vehicle 602 may operate along a navigation path or travel route within an environment. During operation, the vehicle may determine or identify situations to be encountered along its navigation path that may benefit from remote assistance. As shown in scenario 600, while the vehicle travels along a roadway approaching a four way intersection with stop sign 604, vehicle 602 may receive information from a remote source that obstacle 606 (e.g., traffic cones and an open manhole in the intersection) is blocking the vehicle's current navigation path 608. For example, vehicle 602 may receive information that obstacle 606 may be encountered along the vehicle's travel path and may prevent vehicle 602 from navigating straight through the intersection to continue along navigation path 608. Other example situations can involve other types of obstacles that vehicle 602 may encounter during navigation in various environments.

In the embodiment shown in FIG. 6A, vehicle 602 may determine that the presence of obstacle 606 interferes with navigation path 608 of vehicle 602. In other words, vehicle 602 may not be able to continue navigating through the intersection according to navigation path 608 without deviating from planned navigation operations or rules since obstacle 606 is in the way. In some embodiment, the situation may be determined based on historical or previous data that occurred along the navigation path. As a result, vehicle 602 may be configured to request remote assistance since subsequent navigation likely involves vehicle 602 navigating in a way to avoid obstacle 606 that deviates from navigation path 608. For example, vehicle 602 may navigate on the opposite side of the road to circumvent obstacle 606.

As shown, to circumvent obstacle 606, vehicle 602 might need to execute one or more maneuver techniques that may not be included within the maneuver techniques typically executed by vehicle 602 during navigation. In some embodiments, vehicle 602 may not be able to perform one or more maneuver techniques needed to avoid obstacle 606 without prior approval from a remote operator. As such, a vehicle system (e.g., a navigation system) of vehicle 602 may transmit a request to a remote assistance network, which may subsequently connect the vehicle system with a remote computing device of an assistant or operator. The remote operator may provide assistance to help the vehicle systems overcome the issue.

In some embodiments, a vehicle system may be configured to request remote assistance at a threshold duration of time or distance before encountering the situation (e.g., obstacle 606). The threshold duration of time can vary within examples and may depend on external factors, such as the presence of vehicles behind (or nearby) vehicle 602. For example, when a vehicle is detected behind vehicle 602, the threshold duration for requesting remote assistance may be shorter to avoid delaying the vehicle or vehicles waiting.

As vehicle 602 approaches the situation (e.g., obstacles 600), a vehicle system may send information that depicts the situation encountered by vehicle 602 to the remote computing device. In some examples, the information may include a sensor perspective of the environment as measured from the current location of vehicle 602. The sensor perspective may include information and measurements from one or more types of sensors. In some examples, the sensor perspective may be conveyed as a 3D map of the environment generated by a sensor system of the vehicle using one or more types of sensors. The sensor perspective may include images or video from cameras, LIDAR measurements, radar measurements, GPS measurements, and motion measurements from inertial measurement unit (IMU), among other options. As such, the remote computing device that receives the request for assistance may responsively generate a GUI allowing an assistant or operator to review the situation and provide assistance. For example, the remote computing device may generate a GUI similar to GUI 502 shown in FIG. 5. The GUI can convey sensor data in different arrangements and other information related to the situation (e.g., map data).

FIG. 6B further illustrates vehicle 602 determining a set of navigation options to navigate past obstacle 606 as depicted in scenario 600 illustrated in FIG. 6A, according to one or more example embodiments. Vehicle 602 may determine navigation option 610, navigation option 612, and navigation option 614 in response to detecting the presence of or receiving information about obstacle 606 partially blocking navigation path 608. As such, one or more systems of vehicle 602 may communicate a request for remote assistance 610-614 to one or more computing devices in order to obtain remote assistance from a remote operator. For instance, vehicle 602 may transmit the request for assistance to a network configured to receive and subsequently connect vehicle 602 to the remote computing device of an operator available to provide remote assistance.

The request for assistance may include navigation options 610-614 in an initial request for assistance or may subsequently communicate navigation options 610-614 after establishing a secure wireless connection with the remote computing device used by an assistant or operator. Vehicle 602 may utilize sensor data from one or more types of vehicle sensors to determine each navigation option 610-614. In some examples, vehicle 602 may utilize map or GPS data to determine each navigation option 610-614. The number of navigation options 610-614 can vary within embodiments and may depend on aspects of the particular scenario. In particular, scenario 600 shown in FIGS. 6A and 6B involves an intersection that may offer alternative routes that vehicle 602 may use to determine navigation options 610-614 as shown. In other scenarios, vehicle 602 may be able to determine more or fewer navigation options depending on the environment. For example, a scenario involving a vehicle navigating within a parking lot may have limited navigation options if there are numerous vehicles parked in the parking lot limiting available navigation routes.

In some embodiments, vehicle 602 may estimate and associate a score with each navigation option 610-614, which can be subsequently used by the operator or assistant providing remote assistance. Each score may depend on various parameters with each navigation option 610-614 and may be used to provide the operator with a reference system for comparing navigation options 610-614. In some instances, the score for a given navigation option depends on the maneuver techniques used to complete the navigation option. For example, navigation option 614 may have a lower score than navigation options 610, 612 because navigation option 614 requires vehicle 602 to execute a U-turn. The U-turn may be considered a difficult maneuver technique that requires remote approval prior to execution.

In addition, the score for each navigation option can also depend on the amount a navigation option deviates from the original path (i.e., navigation path 608) of vehicle 602. For example, navigation option 610 may have a higher score than navigation options 612, 614 because navigation option 610 helps vehicle 602 resume navigation path 608 quickly while the other navigation options 612, 614 may result in vehicle 602 taking a longer detour to reach the desired destination. Thus, in some examples, map data can be used to determine scores for each navigation option 610-614. The map data can be used to determine route times and other potential factors that are weighed when determining scores for each navigation option.

The score may also depend on other factors. For instance, each score may depend on whether or not vehicle 602 would need to temporarily reduce the safety buffer maintained around vehicle 602 while navigating to complete a particular navigation option. The longer duration (i.e., period of time) that vehicle 602 may need to reduce its safety buffer to execute a navigation option may reduce that option's score. In addition, when the performance of a navigation option requires vehicle 602 to temporarily break one or more rules of the road, the score associated with that option might be decreased relative to other navigation options that may not require breaking any rules of the road. In some embodiments, the score for each navigation option can be determined based on weighted analysis of multiple factors, such as the maneuver techniques used for each navigation option. For example, vehicle 402 may factor and weigh various parameters to develop a score for each navigation option.

When transmitting options to a computing device for remote assistance, vehicle 602 may provide navigation options 610-614 in various formats. In some examples, vehicle 602 may provide navigation options 610-614 in a visual format, such as virtual representations layered on sensor data as further shown in FIG. 6C. Further, a graphical user interface tool template specifically designed for a particular situation may be provided to the computing device. For example, a construction site may have an associated template that enables a remote assistant to review and provide assistance to a vehicle approaching the situation.

In some embodiments, vehicle 602 may only convey a top navigation option (e.g., navigation option 610) to operator or assistant (e.g., a human agent) to receive confirmation before proceeding. Limiting the options may accelerate the overall remote assistance process since the operator has less to review and can approve or modify the proposed option (e.g., navigation option 610). In some instances, vehicle 602 may only convey sensor information (e.g., images or video) of the environment including obstacle 606 and request for assistance with developing a strategy or identifying obstacle 606. Other variations are possible within examples.

FIG. 6C depicts a GUI for enabling remote assistance for scenario 600 illustrated in FIGS. 6A and 6B. Particularly, a computing device may cause GUI 620 to display on a display interface, such as a touchscreen or a high definition (HD) display similar to computing device 500 displaying GUI 502 as illustrated in FIG. 5. As shown, GUI 620 includes environment representation 621, contextual information 630, map data 632, and custom route 634. In further examples, GUI 620 may further include other options. For instance, GUI 620 may include a request more information option, which the remote operator can use to obtain additional sensor data or communicate with a passenger.

Environment representation 621 may convey a perspective of the environment based on sensor data obtained from vehicle sensors, such as cameras. In other embodiments, environment representation 621 may display a larger portion of vehicle's 602 environment to provide additional information for the assistant or operator (e.g., a human operator) to use to make a decision. For instance, environment representation 621 may utilize a combination of sensor measures from areas around the vehicle to portray vehicle 602 within the environment for the human operator to use when providing remote assistance.

In the embodiment shown in FIG. 6C, GUI 620 shows virtual representation of navigation options as option A 622, option B 624, and option C 626. Particularly, option A 622 is a virtual representation of navigation option 610 determined by vehicle 602, option B 624 is a virtual representation of navigation option 612 determined by vehicle 602, and option C 626 is a virtual representation of navigation option 614 determined by vehicle 602. Each option 622-626 is shown as an overlay on environment representation 621 to show how vehicle 602 may navigate and avoid virtual obstacle 628 representing obstacle 606 as shown in FIG. 6A and FIG. 6B. In some examples, options may be shown in different colors and further segmented to include checkpoints that can enable easier monitoring and modification.

In some examples, GUI 620 may only show one option at a given time. Alternatively, an assistant or operator can customize which options are shown. In addition, GUI 620 may enable an operator to adjust one or more aspects of the options as well as provide custom route 634 for vehicle 602 to perform. Custom route 634 may represent a navigation strategy provided by the human operator tasked with providing remote assistance. For example, an operator may draw custom route 634 on environment representation 621 or map data 632 to customize the route utilized by vehicle 602. As such, GUI 620 may also include map data 632, which may correspond to one or more maps that represent the current location of vehicle 602. An operator may use map data 632 to help route plan for a vehicle requesting remote assistance.

In addition, GUI 620 may also include contextual information 630, which can include additional information or data that can help an operator (or the computing device) provide remote assistance to vehicle 602. In the embodiment shown in FIG. 6C, contextual information 630 includes scores and parameters for each option respectively (i.e., option A 622, option B 624, and option C 626). As discussed above, the parameters associated with the performance of an option may influence the score for the option. Particularly, deviation from the desired path (e.g., navigation path 608 shown in FIG. 6A), the difficulty of maneuvers associated with a given option, the time required to complete an option, the quantity and complexity of disfavored maneuvers, and other factors (e.g., how long and the extent of which the vehicle might need to reduce the safety buffer maintained around the vehicle) may impact the score for an option. Contextual information 630 also includes vehicle information and route information. Route information may indicate a current location of vehicle 602 and a target destination (e.g., a location where vehicle 602 is dropping off passengers or objects).

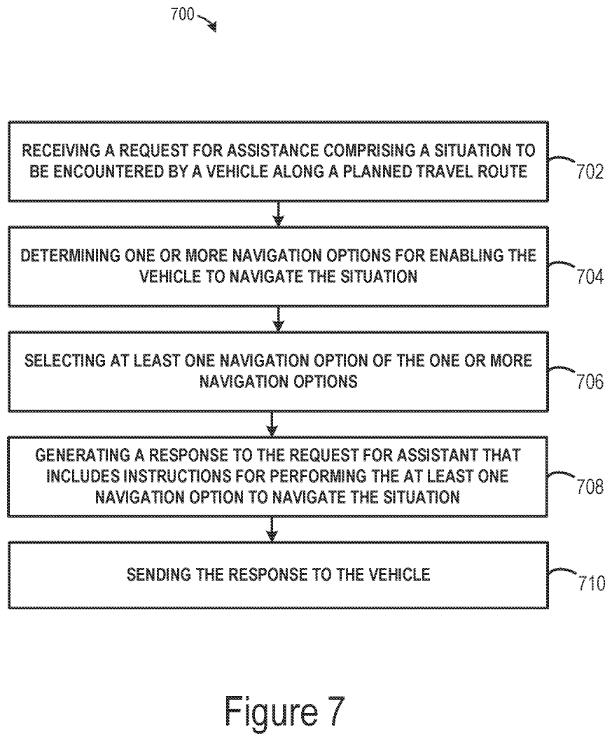

FIG. 7 is a flow chart of a method for providing remote assistance to a vehicle, according to example implementations. Method 700 represents an example method that may include one or more operations, functions, or actions, as depicted by one or more of blocks 702-710, each of which may be carried out by any of the systems, devices, and/or vehicles shown in FIGS. 1-6, among other possible systems. For instance, system 400 depicted in FIG. 4 may enable execution of method 700.

Those skilled in the art will understand that the flowchart described herein illustrates functionality and operations of certain implementations of the present disclosure. In this regard, each block of the flowchart may represent a module, a segment, or a portion of program code, which includes one or more instructions executable by one or more processors for implementing specific logical functions or steps in the process. The program code may be stored on any type of computer readable medium, for example, such as a storage device including a disk or hard drive.

In addition, each block may represent circuitry that is wired to perform the specific logical functions in the process. Alternative implementations are included within the scope of the example implementations of the present application in which functions may be executed out of order from that shown or discussed, including substantially concurrent or in reverse order, depending on the functionality involved, as would be understood by those reasonably skilled in the art.

At block 702, method 700 involves receiving a request for assistance comprising a situation to be encountered by a vehicle along a planned travel route. A vehicle (e.g., an autonomous or autonomously driven vehicle (ADV)) may be operating in an autonomous mode in which the vehicle may use a computing system or device to control the operation of the vehicle with little-to-no human input. For example, a human operator may enter an address into a system of an autonomous vehicle and determine one or more travel routes to a specified destination. The vehicle may then be able to drive, without further input from the human operator (e.g., the human operator does not have to steer or touch the brake/gas pedals), to the specified destination.

During operation, the vehicle may receive information about potential or predetermined situations in the environment that may impede the vehicle from navigating according to the planned travel route (e.g., by one or more obstacles in a current or planned driving route, narrow passageways, accidents, road construction, road conditions, traffic conditions, or other changes or situations in the environment that may impact the navigation of the vehicle. The vehicle system may obtain the information about the situations from other vehicles and/or remote sources (e.g., map systems, GPS systems, fleet management systems, assistance centers, etc.). When the vehicle system determines that the vehicle may encounter a situation along a travel route, the vehicle system may request and obtain remote assistance (e.g., human input) that may help the vehicle effectively overcome the situation (e.g., help the vehicle navigate and/or maneuver the vehicle in an environment). For example, a vehicle system may determine a situation near or along a travel route that may require remote assistance and may request remote assistance to help the vehicle system (e.g., a vehicle control or navigation system) navigate the situation. The situation may be determined based on historical or previous data that occurred along the planned travel route.

At block 704, method 700 involves determining one or more navigation options for enabling the vehicle to navigate the situation. A computing device (e.g., a remote computing device) may receive a remote assistance request for a situation from a vehicle operating in an environment. After receiving the request, the computing device may be configured to determine one or more navigation options for the vehicle to perform for navigating the situation. For instance, the vehicle may be autonomously navigating a neighborhood or city and identify a situation that may be better handled with remote assistance. The vehicle may send a request for assistance to the computing device with details relating to the vehicle's situation. For instance, the request may specify the navigation operations to be performed by the vehicle along the travel route. Further, the vehicle may provide a graphical user interface tool template specifically designed for a particular situation. For example, a construction site may have an associated template that enables a remote assistant to review and provide assistance to a vehicle approaching the situation.

At block 706, method 700 involves selecting at least one navigation option of the one or more navigation options. After determining one or more navigation options for enabling a vehicle to navigate a situation, the computing device may select a navigation option to provide to the vehicle. In some examples, the computing device may present navigation operations to a remote assistant (e.g., a human or computed assistant) so that the remote assistant may review and select the navigation option that may enable the vehicle to navigate the situation to be encountered along a travel path.

At block 708, method 700 involves generating a response to the request for assistance that includes instructions for performing the at least one navigation option to navigate the situation. After selecting a navigation option for enabling a vehicle to navigate a situation, the computing device may generate a response to the request for assistance. For example, the computing device may be configured to provide a response to the vehicle that includes instructions to enable the vehicle to navigate the situation. Without such instructions from the computing device, the vehicle's ability to navigate the situation may be limited.

At block 710, the method 700 involves sending the response to the vehicle. After generating a response to a request for remote assistance, the computing device may send the response to the vehicle. When the vehicle receives instructions from the computing device, the vehicle may be configured to navigate the situation based on the instructions included in the response while also monitoring the environment for changes that may require additional input from the remote assistant.

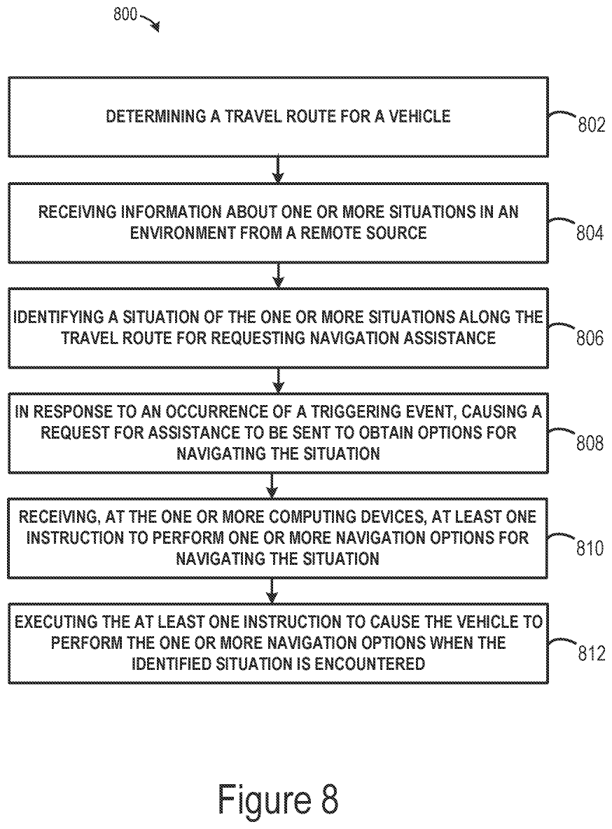

FIG. 8 is a flow chart of a method for enabling a vehicle to request remote assistance, according to example implementations. Method 800 represents an example method that may include one or more operations, functions, or actions, as depicted by one or more of blocks 802-812, each of which may be carried out by any of the systems, devices, and/or vehicles shown in FIGS. 1-4, and 6. In some examples, method 800 may be carried out by a system of a vehicle such as vehicle 100 and/or vehicle 200 as illustrated and described in reference to FIGS. 1 and 2, respectively. For example, the processes described herein may be implemented as special-function and/or configured general-function hardware modules, portions of program code executed by a processor (e.g., the processor 113 within computer system 112) for achieving specific logical functions, determinations, and/or steps described in connection with the flowcharts shown in FIG. 3. Where used, program code can be stored on any type of computer-readable medium (e.g., computer-readable storage medium or non-transitory media, such as data storage 114 described above with respect to computer system 112 and/or a computer program product 600 described below), for example, such as a storage device including a disk or hard drive.

In addition, each block of the flowchart shown in FIG. 8 may represent circuitry that is wired to perform the specific logical functions in the process. Unless specifically indicated, functions in the flowchart shown in FIG. 8 may be executed out of order from that shown or discussed, including substantially concurrent execution of separately described functions, or even in reverse order in some examples, depending on the functionality involved, so long as the overall functionality of the described method is maintained.

At block 802, method 800 includes determining a travel route for a vehicle. A vehicle may be operating in an autonomous mode in which the vehicle may use a computing system or device to control the operation of the vehicle with little-to-no human input. For example, a human operator may enter an address into an autonomous vehicle and determine one or more travel routes to the specified destination. The vehicle may then be able to drive, without further input from the human (e.g., the human does not have to steer or touch the brake/gas pedals), to the specified destination.

While the vehicle is operating autonomously, a sensor system of the vehicle may be receiving data representative of the environment of the vehicle. The computing system of the vehicle may alter the control of the vehicle based on data received from the various sensors. In some examples, the autonomous vehicle may alter a velocity of the autonomous vehicle in response to data from the various sensors. For instance, the autonomous vehicle may change velocity in order to avoid obstacles, obey traffic laws, etc. When the computing system in the vehicle identifies obstacles or other situations encountered or to be encountered by the vehicle, the vehicle may be able to autonomously determine how to proceed (e.g., by altering velocity, changing trajectory to avoid an obstacle, and so on).

At block 804, method 800 involves receiving information about one or more situations in an environment from a remote source. When operating in an environment, a system of a vehicle may receive information about known or predetermined situations (e.g., a road condition, a travel condition, an obstacle, etc.) in the environment that may impede the vehicle from navigating according to a planned travel route. For example, the vehicle system may obtain information about the situations from other vehicles and/or remote sources (e.g., map systems or GPS systems).

In some implementations, a remote source may provide information about situations (e.g., road conditions, travel conditions, obstacles, etc.) in the environment to the vehicle. For instance, the remote source may notify vehicles in the environment about a situation when the vehicle travels within a particular distance of the location of the situation. In some examples, a vehicle may receive information about a situation that is within a certain radius of its current location or within a certain radius of its planned route or routes. Further, vehicles that are pan of a fleet or within a geographic area may receive the information about the situation. The vehicle may use the information to identify the situations along the travel route and route around them or determine other ways to avoid or handle them.

At block 806, method 800 involves identifying a situation of one or more situations along the travel route for requesting navigation assistance. Once a vehicle system receives information about one or more situations in an environment, the vehicle system may determine one or more situations (e.g., obstacles, road conditions, traffic conditions, etc.) in the environment that may require remote assistance. For example, a vehicle system may determine a situation near or along a travel route that may require remote assistance. Once a vehicle system determines that the vehicle may benefit from assistance for a predetermined or known situation along a travel route, the vehicle system may request remote assistance before the vehicle reaches or encounters the situation. In some examples, the situation may be determined based on historical or precious data that occurred in the environment.

At block 808, method 800 involves, in response to an occurrence of a triggering event, causing a request for assistance to be sent to obtain options for navigating the situation. After a system of a vehicle determines that the vehicle may encounter a situation along a travel route that may impede the vehicle in some way (e.g., by one or more obstacles in a current or planned driving route, a narrow passageway, an accident, road construction, a road condition, traffic condition, or other changes or situations in the environment that may impact the navigation of the vehicle), the vehicle system may request and obtain remote assistance (e.g., human input) before the vehicle reaches or encounters the situation. The remote assistance may help the vehicle effectively overcome the situation (e.g., help the vehicle navigate and/or maneuver the vehicle in an environment).

The vehicle system may send a request for assistance upon an occurrence of a triggering event. For example, the vehicle system may use the information about a situation to develop a trigger for requesting remote assistance before the vehicle encounters the situation. In some examples, a remote assistance process may be triggered in response to the vehicle system identifying the situation along the travel route of a vehicle. In other examples, when the vehicle is within a threshold distance from the situation on the travel route, the vehicle system may be triggered to request remote assistance. Further, the vehicle system may be triggered to request remote assistance when the vehicle travels within a particular geographic area or region.

At block 810, method 800 involves receiving at least one instruction to perform one or more navigation options for navigating the situation. After the vehicle sends a request for assistance to a remote operator or assistant, the vehicle system may receive a response from the remote operator. The response may include one or more instructions for performing one or more navigational options for the situation upon encountering the situation.

At block 812, method 800 involves executing the at least one instruction to cause the vehicle to perform the one or more navigation options when the identified situation is encountered. Once the vehicle system receives the response from the remote assistant, the vehicle system may execute the instructions included in the response to cause the vehicle to perform one or more navigation options.

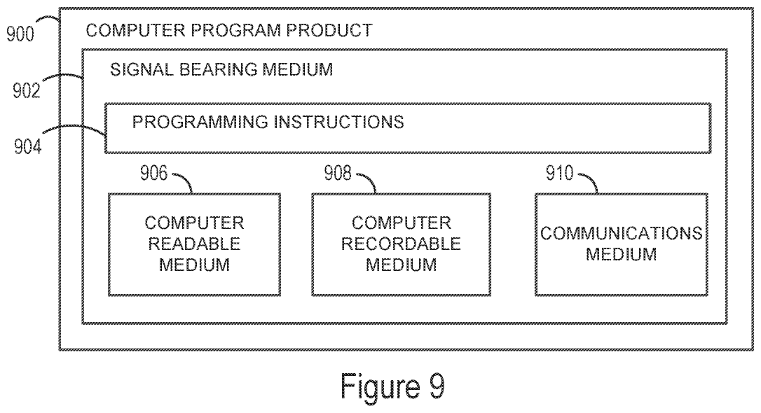

FIG. 9 is a schematic diagram of a computer program, according to an example implementation. In some implementations, the disclosed methods may be implemented as computer program instructions encoded on a non-transitory computer-readable storage media in a machine-readable format, or on other non-transitory media or articles of manufacture.

In the embodiment shown in FIG. 9, computer program product 900 is provided using signal bearing medium 902, which may include one or more programming instructions 904 that, when executed by one or more processors may provide functionality or portions of the functionality described above with respect to FIGS. 1-8.

Signal bearing medium 902 may encompass a non-transitory computer-readable medium 906, such as, but not limited to, a hard disk drive, a Compact Disc (CD), a Digital Video Disk (DVD), a digital tape, memory, components to store remotely (e.g., on the cloud) etc. In some implementations, signal bearing medium 902 may encompass computer recordable medium 908, such as, but not limited to, memory, read/write (R/W) CDs, R/W DVDs, etc.

In some implementations, signal bearing medium 902 may encompass communications medium 910, such as, but not limited to, a digital and/or an analog communication medium (e.g., a fiber optic cable, a waveguide, a wired communications link, a wireless communication link, etc.). Similarly, signal bearing medium 902 may correspond to a remote storage (e.g., a cloud). A computing system may share information with the cloud, including sending or receiving information. For example, the computing system may receive additional information from the cloud to augment information obtained from sensors or another entity. Thus, for example, signal bearing medium 902 may be conveyed by a wireless form of communications medium 910.

One or more programming instructions 904 may be, for example, computer executable and/or logic implemented instructions. In some examples, a computing device such as computer system 112 shown in FIG. 1 or computing device 300 shown in FIG. 3 may be configured to provide various operations, functions, or actions in response to programming instructions 904 conveyed to the computer system by one or more of computer readable medium 906, computer recordable medium 908, and/or communications medium 910. The non-transitory computer readable medium could also be distributed among multiple data storage elements and/or cloud (e.g., remotely), which could be remotely located from each other. Computing device that executes some or all of the stored instructions could be a vehicle. Alternatively, the computing device that executes some or all of the stored instructions could be another computing device, such as a server.

The above detailed description describes various features and functions of the disclosed systems, devices, and methods with reference to the accompanying figures. While various aspects and embodiments have been disclosed herein, other aspects and embodiments will be apparent. The various aspects and embodiments disclosed herein are for purposes of illustration and are not intended to be limiting, with the true scope being indicated by the following claims.

What is claimed is:

1. An apparatus comprising:
a memory configured to store navigation options;
a computing device configured to:
receive a request for assistance comprising a situation to be encountered by a vehicle along a planned travel route, wherein the situation is based on historical data occurring along the planned travel route;
determine one or more navigation options for enabling the vehicle to navigate the situation;
select at least one navigation option of the one or more navigation options;
generate a response to the request for assistant that includes instructions for performing the at least one navigation option to navigate the situation; and
send the response to the vehicle for execution of the instructions.

2. The apparatus of claim 1, wherein the situation includes a road condition, a traffic condition, a driving condition, a weather condition, or a combination thereof.

3. The apparatus of claim 1, wherein the response is sent to the vehicle before the vehicle encounters the situation, and wherein the response includes a suggestion or a particular template for tools to be used for the situation

4. The apparatus of claim 1, wherein the computing device is further configured to:
initiate a display of a graphical user interface, wherein the graphical user interface is configured to visually represent the one or more navigation options; and
detect the selection of the at least one navigation option.

5. The apparatus of claim 1, wherein the request for assistance further includes one or more navigation options, wherein the computing device is positioned remotely from the vehicle, and wherein the computing device receives wireless communications from the vehicle.

6. The apparatus of claim 1, wherein the at least one navigation operation is selected based on input from a remote assistant.

7. The apparatus of claim 1, wherein the computing device is further configured to receive information about one or more situations in an environment and provide the information about the one or more situations to the vehicle, wherein the information about the one or more situations is received from a remote source or one or more vehicles in the environment.

8. The apparatus of claim 7, further comprising validating each of the one or more situations, wherein a particular situation is validated after receiving a certain number of communications from at least one vehicle about the particular situation within a certain time period.

9. The apparatus of claim 1, wherein the computing device is further configured to no longer inform the vehicle of a particular situation after determining the particular situation no longer impedes the travel of the vehicle in an environment.

10. The apparatus of claim 1, wherein the computing device is further configured to initiate display of a graphical user interface, wherein the graphical user interface is configured to display each navigation option with a corresponding score, and wherein the corresponding score for the navigation option represents a difficulty associated with the vehicle performing one or more maneuvers to complete the navigation option.

11. A method comprising:
receiving, at a computing device, a request for assistance comprising a situation to be encountered by a vehicle along a planned travel route, wherein the situation is based on historical data occurring along the planned travel route;
determining, by the computing device, one or more navigation options for enabling the vehicle to navigate the situation;
selecting, by the computing device, at least one navigation option of the one or more navigation options;
generating, by the computing device, a response to the request for assistant that includes instructions for performing the at least one navigation option to navigate the situation; and
sending, by the computing device, the response to the vehicle.

12. The method of claim 11, wherein the situation includes a road condition, a traffic condition, a driving condition, a weather condition, or a combination thereof.

13. The method of claim 11, wherein the response is sent to the vehicle before the vehicle encounters the situation, and wherein the response includes a suggestion or a particular template for tools to be used for the situation.

14. The method of claim 11, wherein the request for assistance includes one or more navigation options, wherein the at least one navigation operation is selected based on input from a remote assistant, wherein the computing device is positioned remotely from the vehicle, and wherein the computing device receives wireless communications from the vehicle.

15. The method of claim 11, further comprising:
initiating, by the computing device, display of a graphical user interface, wherein the graphical user interface is configured to visually represent the one or more navigation options;
detecting, by the computing device, the selection of at least one navigation option.

16. The method of claim 11, further comprising receiving information about one or more situations in an environment and providing the information about the one or more situations to the vehicle, wherein the information about one or more situations is received from a remote source or one or more vehicles in the environment.

17. The method of claim 11, further comprising validating each of the one or more situations, wherein a particular situation is validated after receiving a certain number of communications from at least one vehicle encountering the particular situation within a certain time period.

18. A method comprising:
determining, by one or more computing devices, a travel route for a vehicle;
receiving, by the one or more computing devices, information about one or more situations in an environment from a remote source;
identifying, by the one or more computing devices, a situation of the one or more situations along the travel route for requesting navigation assistance;
in response to an occurrence of a triggering event, causing a request for assistance to be sent to obtain options for navigating the situation, wherein the request for assistance is sent before the vehicle encounters the situation;
receiving, by the one or more computing devices, at least one instruction to perform one or more navigation options for navigating the situation; and
executing the at least one instruction to cause the vehicle to perform the one or more navigation options when the identified situation is encountered.

19. The method of claim 18, wherein the situation includes a road condition, a traffic condition, a driving condition, a weather condition, or a combination thereof, wherein the at least one instruction is received before the vehicle reaches the situation, and wherein the occurrence of the triggering event is based on a location of the vehicle, a distance to the situation, a time period to the situation, or a combination thereof.

20. The method of claim 18 wherein identifying the situation along the travel route further comprises determining that a confidence level for navigating the situation is below a threshold value.
